(19) United States
(12) Patent Application Publication
(10) Pub. No.: US 2025/0258562 A1
(43) Pub. Date: Aug. 14, 2025

(54) ELECTRONIC DEVICE

(71) Applicant: Samsung Display Co., Ltd., Yongin-si (KR)

(72) Inventor: HYUNGBAE KIM, Yongin-si (KR)

(21) Appl. No.: 18/986,142

(22) Filed: Dec. 18, 2024

(30) Foreign Application Priority Data
Feb. 8, 2024 (KR) 10-2024-0019406

(51) Int. Cl. G06F 3/041; G06F 3/044

(52) U.S. Cl. CPC G06F 3/04164; G06F 3/0446; G06F 2203/04111; G06F 2203/04112; G06F 2203/04114

(57) ABSTRACT

An electronic device includes a sensor layer including a sensing region, a peripheral region, first electrode groups in a first direction, second electrode groups crossing the first electrode groups in a second direction, first trace lines electrically connected to the first electrode groups, and second trace lines electrically connected to the second electrode groups, and including a (2-1)-th trace line electrically connected to one of the second electrode groups, and having a first length in the second direction, and a (2-2)-th trace line spaced apart from the (2-1)-th trace line in the first direction while extending in the second direction, and having a second length in the second direction that is substantially equal to the first length, and a sensor driver configured to drive the sensor layer, and to selectively operate in a first mode for sensing a touch input, or in a second mode for sensing a pen input.

### CROSS-REFERENCE TO RELATED APPLICATION

The present application claims priority to, and the benefit of, Korean Patent Application No. 10-2024-0019406, filed on Feb. 8, 2024, in the Korean Intellectual Property Office, the entire disclosure of which is incorporated herein by reference.

### BACKGROUND

Embodiments of the present disclosure described herein relate to an electronic device capable of sensing an input made by a pen.

Multimedia electronic devices, such as a television (TV), a cellular phone, a tablet computer, a laptop computer, a navigation, or a game console, include a display device that displays an image. Electronic devices may include an sensor layer (or an input sensor) that provides a touch-based input manner for enabling a user to intuitively, conveniently, and easily input information or a command, in addition to a general input manner, such as a button, a keyboard, or a mouse. The sensor layer may sense a touch or an input of a user. Meanwhile, the demand for using a pen is increased for a user familiar with the input of information through handwriting or for a fine touch input for a corresponding application program (for example, an application program for sketching or drawing).

### SUMMARY

Embodiments of the present disclosure provide an electronic device capable of sensing an input made by a pen.

According to one or more embodiments, an electronic device may include a sensor layer including a sensing region, a peripheral region adjacent to the sensing region, first electrode groups arranged in a first direction, second electrode groups crossing the first electrode groups, and arranged in a second direction crossing the first direction, first trace lines electrically connected to the first electrode groups, and second trace lines electrically connected to the second electrode groups, and including a (2-1)-th trace line electrically connected to one of the second electrode groups, and having a first length in the second direction, and a (2-2)-th trace line spaced apart from the (2-1)-th trace line in the first direction while extending in the second direction, and having a second length in the second direction that is substantially equal to the first length, and a sensor driver configured to drive the sensor layer, and to selectively operate in a first mode for sensing a touch input, or in a second mode for sensing a pen input.

Each of the second electrode groups may include a first divided electrode, and a second divided electrode spaced apart from the first divided electrode in the first direction, wherein the (2-1)-th trace line is electrically connected to the first divided electrode, and the (2-2)-th trace line is electrically connected to the second divided electrode.

At least a portion of the (2-1)-th trace line and a portion of the (2-2)-th trace line may overlap the sensing region, wherein the first length of the (2-1)-th trace line overlaps the sensing region, and wherein the second length of the (2-2)-th trace line overlaps the sensing region.

The (2-1)-th trace line may be connected to the first divided electrode adjacent to the second divided electrode, wherein the (2-2)-th trace line is connected to the second divided electrode adjacent to the first divided electrode.

The (2-1)-th trace line and the (2-2)-th trace line may overlap the peripheral region, and may be spaced apart from each other with the first divided electrode and the second divided electrode therebetween.

The second electrode groups may include a (2-1)-th electrode group, a (2-2)-th electrode group, and a (2-3)-th electrode group sequentially arranged in the second direction, wherein the (2-1)-th electrode group includes a (1-1)-th divided electrode, and a (2-1)-th divided electrode spaced apart from the (1-1)-th divided electrode in the first direction, wherein the (2-2)-th electrode group includes a (1-2)-th divided electrode, and a (2-2)-th divided electrode spaced apart from the (1-2)-th divided electrode in the first direction, wherein the (2-3)-th electrode group includes a (1-3)-th divided electrode, and a (2-3)-th divided electrode spaced apart from the (1-3)-th divided electrode in the first direction, and wherein the second trace lines includes a (1-1)-th divided trace line electrically connected to the (1-1)-th divided electrode, a (2-1)-th divided trace line electrically connected to the (2-1)-th divided electrode, a (1-2)-th divided trace line electrically connected to the (1-2)-th divided electrode, a (2-2)-th divided trace line electrically connected to the (2-2)-th divided electrode, a (1-3)-th divided trace line electrically connected to the (1-3)-th divided electrode, and a (2-3)-th divided trace line electrically connected to the (2-3)-th divided electrode.

A gap between the (1-1)-th divided trace line and the (2-1)-th divided trace line may be narrower than a gap between the (2-1)-th divided trace line and the (1-2)-th divided trace line.

The (1-1)-th divided trace line, the (2-1)-th divided trace line, the (1-2)-th divided trace line, the (2-2)-th divided trace line, the (1-3)-th divided trace line, and the (2-3)-th divided trace line may be sequentially arranged in the first direction.

The (1-3)-th divided trace line, the (2-3)-th divided trace line, the (1-1)-th divided trace line, the (2-1)-th divided trace line, the (1-2)-th divided trace line, and the (2-2)-th divided trace line may be sequentially arranged in the first direction.

A width of the (1-1)-th divided electrode in the first direction may be narrower than a width of the (1-2)-th divided electrode in the first direction, wherein a width of the (2-1)-th divided electrode in the first direction is wider than a width of the (2-2)-th divided electrode in the first direction.

A width of the (1-3)-th divided electrode in the first direction may be wider than the width of the (1-2)-th divided electrode in the first direction, wherein a width of the (2-3)-th divided electrode in the first direction is narrower than the width of the (2-2)-th divided electrode in the first direction.

A width of the (1-3)-th divided electrode in the first direction may be narrower than the width of the (1-1)-th divided electrode in the first direction, wherein a width of the (2-3)-th divided electrode in the first direction is wider than the width of the (2-1)-th divided electrode in the first direction.

A gap between the (1-3)-th divided electrode and the (2-3)-th divided electrode may overlap the (2-1)-th divided electrode and the (2-2)-th divided electrode, when viewed from the second direction.

A gap between the (1-3)-th divided electrode and the (2-3)-th divided electrode may overlap the (1-1)-th divided electrode and the (1-2)-th divided electrode, when viewed from the second direction.

The (2-1)-th trace line may include a first portion extending in the first direction, and a second portion extending in the second direction from the first portion, wherein the (2-2)-th trace line faces the second portion.

The sensor driver may be configured to receive a first signal through the (2-1)-th trace line and a second signal through the (2-2)-th trace line, and to generate first data by performing a differential computing operation with respect to the first signal and the second signal.

The second trace lines may include a (2-3)-th trace line electrically connected to another second electrode group among the second electrode groups, and a (2-4)-th trace line spaced apart from the (2-3)-th trace line in the first direction while extending in the second direction, wherein the sensor driver is configured to receive a third signal through the (2-3)-th trace line and a fourth signal through the (2-4)-th trace line, to generate second data by performing a differential computing operation with respect to the third signal and the fourth signal, and to generate third data by performing the differential computing operation with respect to the first data and the second data.

The sensor driver may be configured to generate the first data and the second data through at least one of analog differential processing or digital differential processing, wherein the sensor driver is configured to generate the third data through at least one of the analog differential processing or the digital differential processing.

According to one or more embodiments, an electronic device may include a sensor layer including a sensing region, a peripheral region adjacent to the sensing region, first electrode groups in the sensing region and arranged in a first direction, second electrode groups in the sensing region, and arranged in a second direction crossing the first direction, while crossing the first electrode groups, a first line electrically connected to one of the second electrode groups, a second line having a length substantially equal to a length of the first line in the second direction, in the sensing region, a third line electrically connected to another of the second electrode groups, and a fourth line having a length substantially equal to a length of the third line in the second direction, in the sensing region, and a sensor driver configured to drive the sensor layer, configured to selectively operate in a first mode for sensing a touch input or in a second mode for sensing a pen input, configured to receive a first signal through the first line and a second signal through the second line, configured to generate first data by performing a differential computing operation with respect to the first signal and the second signal, configured to receive a third signal through the third line and a fourth signal through the fourth line, configured to generate second data by performing a differential computing operation with respect to the third signal and the fourth signal, and configured to generate third data by performing a differential computing operation with respect to the first data and the second data.

The one of the second electrode groups may include a first divided electrode, and a second divided electrode spaced apart from the first divided electrode in the first direction, wherein the another of the second electrode groups includes a third divided electrode, and a fourth divided electrode spaced apart from the third divided electrode in the first direction, wherein the first line is electrically connected to the first divided electrode, and the second line is electrically connected to the second divided electrode, and wherein the third line is electrically connected to the third divided electrode, and the fourth line is electrically connected to the fourth divided electrode.

The first line and the second line may be insulated from one of the third divided electrode or the fourth divided electrode while crossing the third divided electrode and the fourth divided electrode.

The first line may include a first portion extending in the first direction, and a second portion extending in the second direction from the first portion, wherein the second line faces the second portion of the first line.

The sensor driver may be connected to one end of the second line, and an opposite end of the second line is floated.

According to one or more embodiments, an electronic device may include a first electrode groups in a sensing region, and arranged in a first direction, second electrode groups crossing the first electrode groups in the sensing region, and arranged in a second direction crossing the first direction, a first line in the sensing region, and electrically connected to one of the second electrode groups, a second line in the sensing region, and adjacent to the first line in the first direction, and a third line in the sensing region, and electrically connected to another of the second electrode groups, wherein a gap between the first line and the second line is narrower than a gap between the second line and the third line, and wherein a length of a portion of the first line in the sensing region is substantially equal to a length of a portion of the second line in the sensing region.

The one of the second electrode groups may include a first divided electrode, and a second divided electrode spaced apart from the first divided electrode in the first direction, wherein the first line is electrically connected to the first divided electrode, and the second line is electrically connected to the second divided electrode.

The first line may include a first portion extending in the first direction, and a second portion extending in the second direction from the first portion, wherein the second line faces the second portion of the first line while extending in the second direction.

### BRIEF DESCRIPTION OF THE DRAWINGS

The above and other aspects of the present disclosure will become apparent by describing in detail embodiments thereof with reference to the accompanying drawings.

FIG. 1A is a perspective view illustrating an electronic device according to one or more embodiments of the present disclosure.

FIG. 1B is a bottom perspective view illustrating an electronic device according to one or more embodiments of the present disclosure.

FIG. 2 is a perspective view illustrating an electronic device according to one or more embodiments of the present disclosure.

FIG. 3 is a perspective view of an electronic device according to one or more embodiments of the present disclosure.

FIG. 4 is a cross-sectional view schematically illustrating a display panel according to one or more embodiments of the present disclosure.

FIG. 5 is a view illustrating an operation of an electronic device according to one or more embodiments.

FIG. 6A is a cross-sectional view of a display panel according to one or more embodiments of the present disclosure.

FIG. 6B is a cross-sectional view of a sensor layer according to one or more embodiments of the present disclosure.

FIG. 7 is a plan view of a sensor layer according to one or more embodiments of the present disclosure.

FIG. 8 is an enlarged plan view illustrating one sensing unit according to one or more embodiments of the present disclosure.

FIG. 9A is a plan view illustrating a first conductive layer of a sensing unit according to one or more embodiments of the present disclosure.

FIG. 9B is a plan view illustrating a second conductive layer of a sensing unit according to one or more embodiments of the present disclosure.

FIG. 9C is a cross-sectional view of a sensor layer according to one or more embodiments of the present disclosure, which is taken along the line I-I′ shown in FIGS. 9A and 9B, respectively.

FIG. 10A is a plan view illustrating a first conductive layer of a sensing unit according to one or more embodiments of the present disclosure.

FIG. 10B is a plan view illustrating a second conductive layer of a sensing unit according to one or more embodiments of the present disclosure.

FIG. 10C is a cross-sectional view of a sensor layer taken along the line II-II′ illustrated in FIGS. 10A and 10B according to one or more embodiments of the present disclosure.

FIG. 11A is an enlarged plan view of region AA′ illustrated in FIG. 9A.

FIG. 11B is an enlarged plan view of region BB′ illustrated in FIG. 9B.

FIG. 12 is a plan view of a sensor layer according to one or more embodiments of the present disclosure.

FIG. 13A is a view illustrating an operation of a sensor driver according to one or more embodiments of the present disclosure.

FIG. 13B is a view illustrating an operation of a sensor driver according to one or more embodiments of the present disclosure.

FIG. 14 is a view illustrating a first mode, according to one or more embodiments of the present disclosure.

FIG. 15 is a view illustrating a second mode according to one or more embodiments of the present disclosure

FIG. 16A is a graph illustrating a waveform of a first signal according to one or more embodiments of the present disclosure.

FIG. 16B is a graph illustrating a waveform of a second signal according to one or more embodiments of the present disclosure.

FIG. 17A is a view illustrating a second mode according to one or more embodiments of the present disclosure.

FIG. 17B is a view illustrating a second mode according to one or more embodiments of the present disclosure.

FIG. 18A is a view illustrating some components of a sensor layer according to one or more embodiments of the present disclosure.

FIG. 18B is an equivalent circuit diagram of an input device and a sensor layer according to one or more embodiments of the present disclosure;

FIG. 19 is a view illustrating a sensor driver according to one or more embodiments of the present disclosure;

FIG. 20 is a view illustrating a sensor driver according to one or more embodiments of the present disclosure;

FIG. 21 is a view illustrating a sensor driver according to one or more embodiments of the present disclosure;

FIG. 22A is a plan view of a sensor layer according to one or more embodiments of the present disclosure.

FIG. 22B is a view illustrating some components of a sensor layer according to one or more embodiments of the present disclosure.

FIG. 23 is a plan view of a sensor layer according to one or more embodiments of the present disclosure.

FIG. 24A is a view illustrating some components of a sensor layer according to one or more embodiments of the present disclosure.

FIG. 24B is a view illustrating a sensing unit in a second mode according to one or more embodiments of the present disclosure.

FIG. 25 is a plan view of a sensor layer according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

The terms “part” and “unit” refer to a software component or a hardware component to perform a corresponding function. The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware, to process data or digital signals. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Circuit hardware may include, for example, application specific integrated circuits (ASICs), general purpose or special purpose central processing units (CPUs) that is configured to execute instructions stored in a non-transitory storage medium, digital signal processors (DSPs), graphics processing units (GPUs), and programmable logic devices, such as field programmable gate arrays (FPGAs).

Software components may indicate data used by executable codes and/or executable codes in a storage medium which is able to be addressed. Accordingly, software components may be, for example, object-oriented software components, class components, and task components, and may include processes, functions, properties, procedures, subroutines, program code segments, drivers, firmware, microcodes, circuits, data, database, data structures, tables, arrangements or variables. Further, the various components of these devices may be a process or thread, running on one or more processors, in one or more computing devices, executing computer program instructions and interacting with other system components for performing the various functionalities described herein. The computer program instructions are stored in a memory that may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, embodiments of the present disclosure will be described with reference to accompanying drawings.

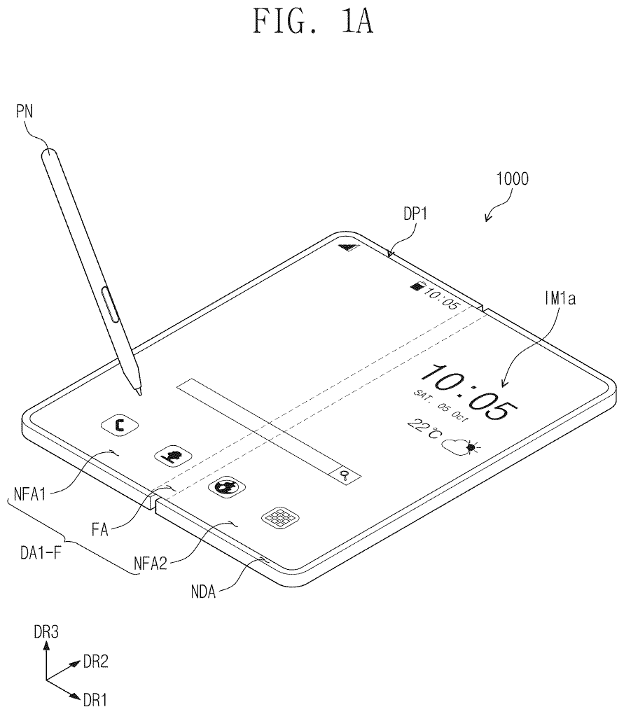

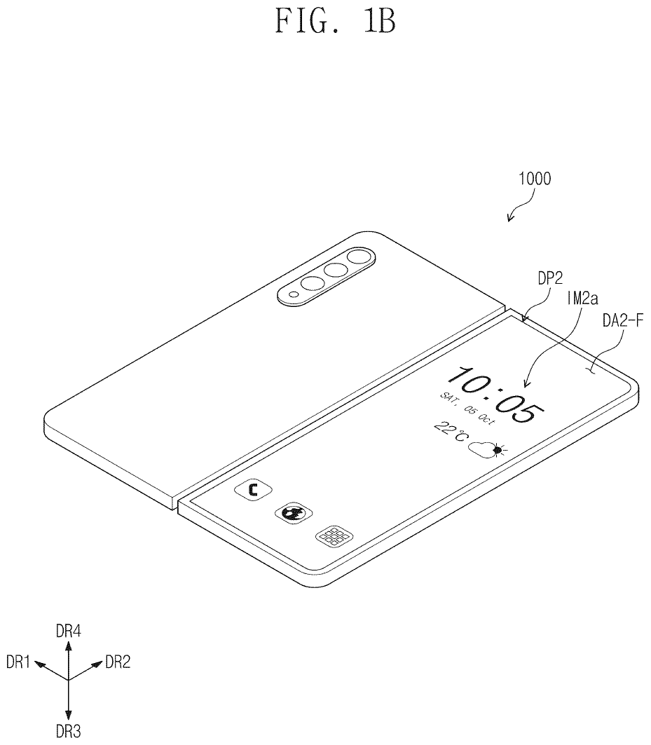

FIG. 1A is a perspective view of an electronic device 1000 according to one or more embodiments of the present disclosure. FIG. 1B is a bottom perspective view of the electronic device 1000 according to one or more embodiments of the present disclosure.

Referring to FIGS. 1A and 1B, the electronic device 1000 may be a device activated in response to an electrical signal. For example, the electronic device 1000 may display an image and sense inputs applied from the outside. The external input may be a user input. The input of the user may include any one of various external inputs, such as a part of a physical body of the user, a pen, light, heat, or pressure.

The electronic device 1000 may include a first display panel DP1 and a second display panel DP2. The first display panel DP1 and the second display panel DP2 may be separated from each other. The first display panel DP1 may be referred to as a main display panel, and the second display panel DP2 may be an auxiliary display panel or an external display panel.

The first display panel DP1 may include a first display unit DA1-F and a peripheral area NDA around the first display unit DA1-F. The second display panel DP2 may include a second display unit DA2-F. The area of the second display panel DP2 may be smaller than the area of the first display panel DP1. The area of the first display unit DA1-F may be greater than the area of the second display unit DA2-F to correspond to the sizes of the first display panel DP1 and the second display panel DP2.

The first display unit DA1-F may have a plan substantially parallel to a plane defined by a first direction DR1 and a second direction DR2, when the electronic device 1000 is unfolded. The thickness direction of the electronic device 1000 may be parallel to a third direction DR3 crossing the first direction DR1 and the second direction DR2. Accordingly, front surfaces (or top surfaces) and back surfaces (or bottom surfaces) of members constituting the electronic device 1000 may be defined based on the third direction DR3.

The first display panel DP1 or the first display unit DA1-F may include a folding region FA being folded and unfolded, and a plurality of non-folding regions NFA1 and NFA2 spaced apart from each other while interposing the folding region FA between the non-folding regions NFA1 and NFA2. The second display panel DP2 may overlap any one of the plurality of non-folding regions NFA1 or NFA2. For example, the second display panel DP2 may overlap the first non-folding region NFA1.

The display direction of a first image IM1a displayed in a portion of the first display panel DP1, for example, in the first non-folding region NFA1, and the display direction of a second image IM2a displayed on the second display panel DP2 may be opposite to each other. For example, the first image IM1a may be displayed in the third direction DR3, and the second image IM2a may be displayed in a fourth direction DR4 opposite to the third direction DR3.

According to one or more embodiments of the present disclosure, the folding region FA may be bent about a folding axis extending in a direction parallel to a longer side of the electronic device 1000, for example, a direction parallel to the second direction DR2. The folding region FA has a corresponding curvature and a corresponding radius of curvature, when the electronic device 1000 is folded. The first non-folding region NFA1 and the second non-folding region NFA2 may face each other, and the electronic device 1000 may be in an inner-folding state, such that that the first display unit DA1-F is not exposed to the outside.

According to one or more embodiments of the present disclosure, the electronic device 1000 may be in an outer-folding state such that the first display unit DA1-F is exposed to the outside. According to one or more embodiments of the present disclosure, the electronic device 1000 may be the inner-folding state or the outer-folding state from the state in which the electronic device 1000 is unfolded, and the present disclosure is not limited thereto.

Although FIG. 1A illustrates that one folding region FA is defined in the electronic device 1000, the present disclosure is not limited thereto. For example, a plurality of folding axes and a plurality of folding regions corresponding to the plurality of folding axes are defined in the electronic device 1000, and the electronic device 1000 may be in the inner-folding state or the outer-folding state in each of the plurality of folding regions, from the state in which the each of the plurality of folding regions is unfolded.

According to one or more embodiments of the present disclosure, at least one of the first display panel DP1 or the second display panel DP2 may sense an input by a pen PN even without a digitizer. Accordingly, because the digitizer to sense the pen PN is omitted, the electronic device 1000 may be thinner and lighter with improved flexibility due to the digitizer added. Accordingly, the design may sense the pen PN even in the second display panel DP2 in addition to the first display panel DP1.

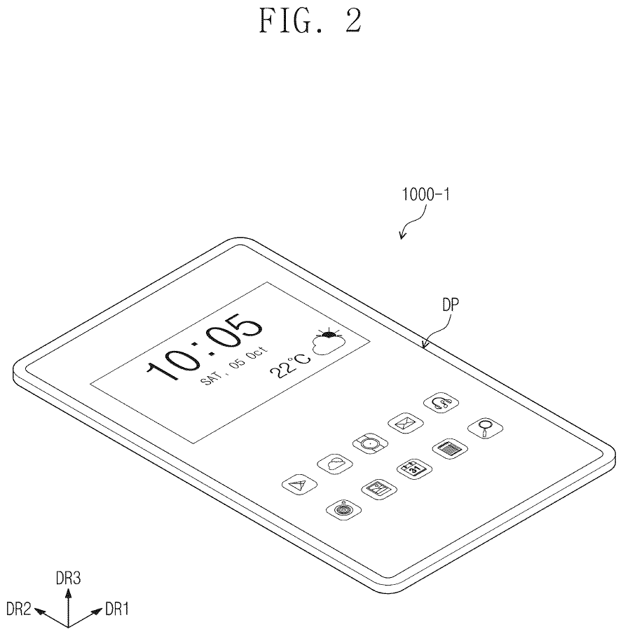

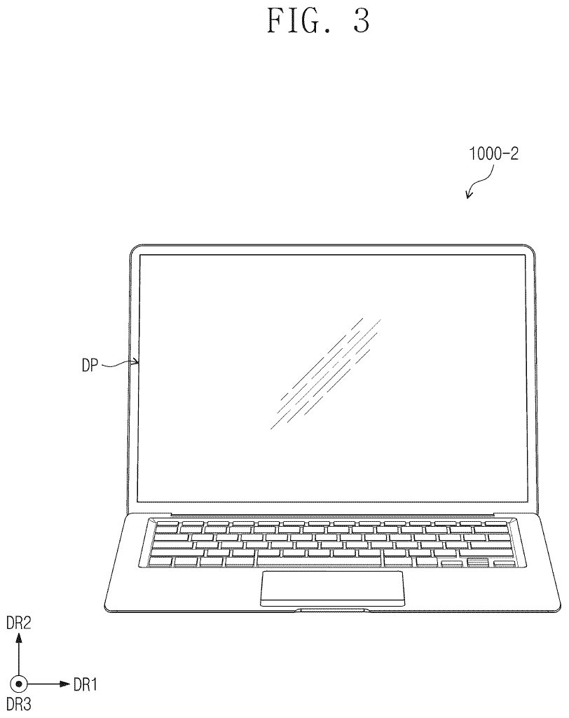

FIG. 2 is a perspective view of an electronic device 1000-1 according to one or more embodiments of the present disclosure. FIG. 3 is a perspective view of an electronic device 1000-2 according to one or more embodiments of the present disclosure.

Although FIG. 2 illustrates that the electronic device 1000-1 is a cellular phone, the electronic device 1000-1 may include a display panel DP. Although FIG. 3 illustrates that the electronic device 1000-2 is a laptop computer, the electronic device 1000-2 may include the display panel DP. Although FIG. 3 is the perspective view of an electronic device 1000-2, the coordinate axes included in FIG. 3 are displayed based on the display panel DP within the electronic device 1000-2.

According to one or more embodiments of the present disclosure, the display panel DP may sense inputs applied to the outside. The external input may be a user input. The input of the user may include any one of various external inputs, such as a part of a physical body of the user, the pen PN (see FIG. 1A), light, heat, or pressure.

According to one or more embodiments of the present disclosure, the display panel DP may sense an input made by the pen PN even without the digitizer. Accordingly, because the digitizer to sense the pen PN is omitted, the electronic device 1000-1 and 1000-2 may be thinner and lighter, which results from the digitizer added.

Although FIG. 1A illustrates the electronic device 1000 in a foldable type, and FIG. 2 illustrates the electronic device 1000-1 in a bar type, the present disclosure is not limited thereto. For example, the following description may be applied to various electronic devices such as a rollable-type electronic device, a slidable-type electronic device, or a stretchable-type electronic device.

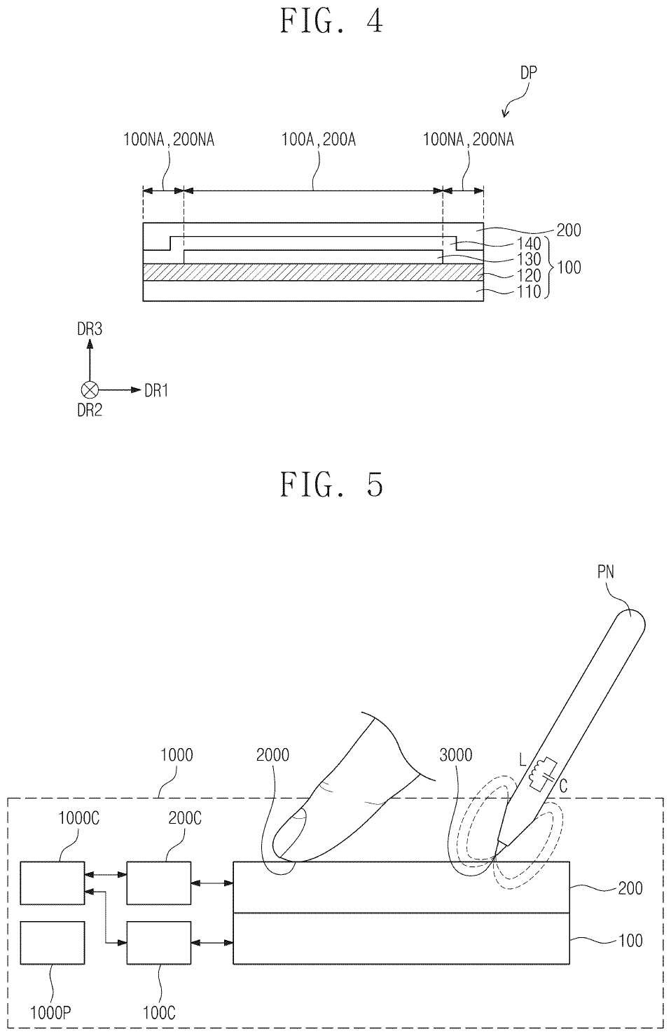

FIG. 4 is a cross-sectional view schematically illustrating the display panel DP according to one or more embodiments of the present disclosure.

Referring to FIG. 4, the display panel DP may include a display layer 100 and a sensor layer 200.

The display layer 100 may be a component that substantially generates an image. The display layer 100 may include a display region 100A and a non-display region 100NA adjacent to the display region 100A. The image may be displayed on the display region 100A.

The display layer 100 may be a light-emitting display layer. For example, the display layer 100 may be an organic light-emitting display layer, an inorganic light-emitting display layer, an organic inorganic light-emitting display layer, a quantum dot display layer, a micro-LED display layer, or a nano-LED display layer. The display layer 100 may include a base layer 110, a circuit layer 120, a light-emitting element layer 130, and an encapsulation layer 140.

The base layer 110 may be a member that provides a base surface for disposing the circuit layer 120. The base layer 110 may have a multi-layer structure or a single-layer structure. The base layer 110 may be a glass substrate, a metal substrate, a silicon substrate, or a polymer substrate, and the present disclosure is not limited thereto.

The circuit layer 120 may be located on the base layer 110. The circuit layer 120 may include an insulating layer, a semiconductor pattern, a conductive pattern, and a signal line. An insulating layer, a semiconductor layer, and a conductive layer may be formed on the base layer 110 through a coating or deposition process. Thereafter, the insulating layer, the semiconductor layer, and the conductive layer may then be selectively patterned through multiple photolithography processes.

The light-emitting element layer 130 may be located on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro-LED, or a nano-LED.

The encapsulation layer 140 may be located on the light-emitting element layer 130. The encapsulation layer 140 may protect the light-emitting element layer 130 from foreign substances such as moisture, oxygen, and dust particles.

The sensor layer 200 may be located on the display layer 100. The sensor layer 200 may include a sensing region 200A and a peripheral region 200NA adjacent to the sensing region 200A. The sensing region 200A may overlap the display region 100A, and the peripheral region 200NA may overlap the non-display region 100NA.

The sensor layer 200 may sense an external input applied from the outside. The sensor layer 200 may be an integral-type sensor formed subsequently during the fabricating process of the display layer 100, or an external-type sensor attached to the display layer 100. The sensor layer 200 may be referred to as a sensor, an input sensor layer, an input-sensing panel, or an electronic device for sensing input coordinates.

According to one or more embodiments of the present disclosure, the sensor layer 200 may sense an input made by a passive-type input unit, such as a physical body of a user, and an input to an input device to generate a magnetic field having a corresponding resonance frequency. The input device may be referred to as a pen, an input pen, a magnetic pen, a stylus pen, or an electro-magnetic resonance (EMR) pen.

FIG. 5 is a view illustrating the operation of the electronic device 1000, according to one or more embodiments of the present disclosure.

Referring to FIG. 5, the electronic device 1000 may include the display layer 100, the sensor layer 200, a display driver 100C, a sensor driver 200C, a main driver 1000C, and a power supply circuit 1000P.

The sensor layer 200 may sense a first input 2000 or a second input 3000 applied thereto from an outside. Each of the first input 2000 and the second input 3000 may make a change in capacitance of the sensor layer 200 or may induce an induction current to the sensor layer 200. For example, the first input 2000 may be made by a passive type input unit, such as the physical body of a user. The second input 3000 may be made by the pen PN or by a radio frequency integrated circuit (RFIC) tag. For example, the pen PN may be a passive type pen or an active type pen.

According to one or more embodiments of the present disclosure, the pen PN may be a device to generate a magnetic field having a corresponding resonance frequency. The pen PN may be configured to transmit an output signal through an EMR scheme. The pen PN may be referred to as an input device, an input pen, a magnetic pen, a stylus pen, or an EMR pen.

The pen PN may include an RLC resonance circuit. The RLC resonance circuit may include an inductor L and a capacitor C. According to one or more embodiments of the present disclosure, the RLC resonance circuit may be a variable resonance circuit that varies a resonance frequency. In this case, the inductor L may be a variable inductor and/or the capacitor C may be a variable capacitor, but the present disclosure is not particularly limited thereto.

The inductor L generates a current by a magnetic field formed in the electronic device 1000, for example, the sensor layer 200. However, the present disclosure is not specifically limited thereto. For example, when the pen PN operates in an active type, the pen PN may generate a current even when the magnetic field is not provided from the outside. The generated current is transmitted to the capacitor C. The capacitor C charges the current received from the inductor L, and discharges the charged current to the inductor L. Thereafter, the inductor L may discharge a magnetic field having the resonance frequency. The induction current may flow through the sensor layer 200 by the magnetic field discharged from the pen PN, and the induction current may be transmitted to the sensor driver 200C while serving as a received signal (or a sensing signal, a signal).

The main driver 1000C may control an overall operation of the electronic device 1000. For example, the main driver 1000C may control the operations of the display driver 100C and the sensor driver 200C. The main driver 1000C may include at least one microprocessor, and may further include a graphic controller. The main driver 1000C may be referred to as an application processor, a central processing unit, or a main processor.

The display driver 100C may control the display layer 100. The display driver 100C may receive image data and a control signal from the main driver 1000C. The control signal may include various signals. For example, the control signal may include an input vertical synchronization signal, an input horizontal synchronization signal, a main clock, and a data enable signal.

The sensor driver 200C may control the sensor layer 200. The sensor driver 200C may receive a control signal from the main driver 1000C. The control signal may include a clock signal of the sensor driver 200C. In addition, the control signal may further include a mode-determining signal for determining driving modes of the sensor driver 200C and the sensor layer 200.

The sensor driver 200C may be integrated in the form of an integrated circuit (IC), and may be electrically connected to the sensor layer 200. For example, the sensor driver 200C may be directly mounted on a corresponding region of the display panel, or may be mounted through a chip-on-film (COF) scheme on a separate printed circuit board such that the sensor driver 200C may be electrically connected to the sensor layer 200.

The sensor driver 200C and the sensor layer 200 may alternatively operate in a first mode or a second mode. For example, the first mode may be a mode for sensing a touch input, such as the first input 2000. The second mode may be a mode for sensing the pen input, such as the second input 3000. The first mode may be referred to as a touch-sensing mode, and the second mode may be referred to as a pen-sensing mode.

The switching between the first mode and the second mode may be performed in various switching manners. For example, the sensor driver 200C and the sensor layer 200 may operate in the first mode and the second mode in a time-division scheme to sense the first input 2000 and the second input 3000. Alternatively, the switching between the first mode and the second mode may be made by the selection of the user or a corresponding behavior (or input) of the user. Alternatively, any one of the first mode or the second mode may be activated or deactivated or switched to a remaining mode among the first mode and the second mode through the specification application being activated or deactivated. Alternatively, the sensor driver 200C and the sensor layer 200 may be maintained in the first mode when sensing the first input 2000, or may be maintained in the second mode when sensing the second input 3000, while alternatively operating in the first mode and the second mode.

The sensor driver 200C may calculate information on coordinates of an input, based on a signal received from the sensor layer 200, and may provide a coordinate signal having the coordinate information to the main driver 1000C. The main driver 1000C executes an operation corresponding to the user input, in response to the coordinate signal. For example, the main driver 1000C may operate the display driver 100C such that a new application image is displayed on the display layer 100.

The power supply circuit 1000P may include a power management integrated circuit (PMIC). The power supply circuit 1000P may generate a plurality of driving voltages for driving the display layer 100, the sensor layer 200, the display driver 100C, and the sensor driver 200C. For example, the plurality of driving voltages may include a gate high voltage, a gate low voltage, a first driving voltage (e.g., the voltage of ELVSS), a second driving voltage (e.g., the voltage of ELVDD), or an initialization voltage.

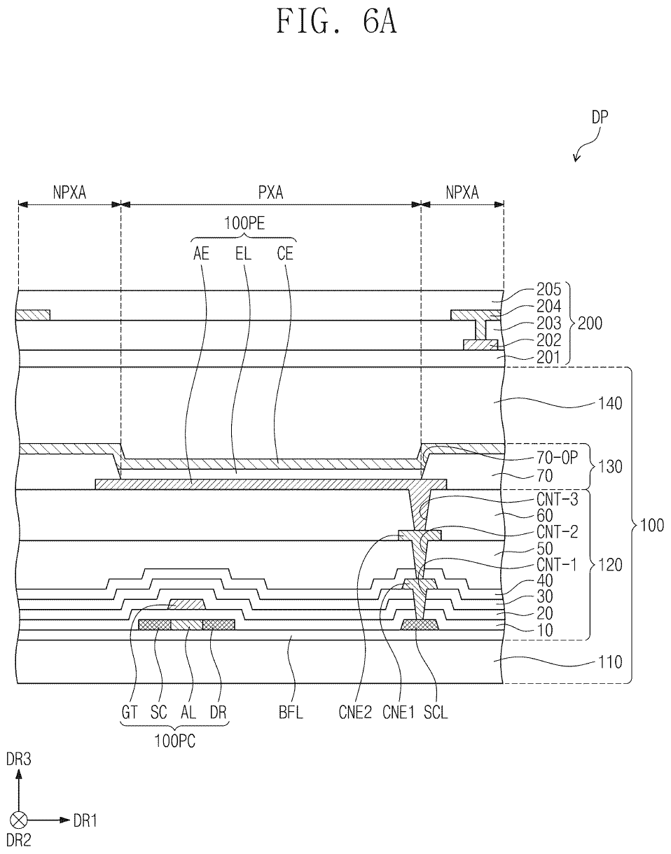

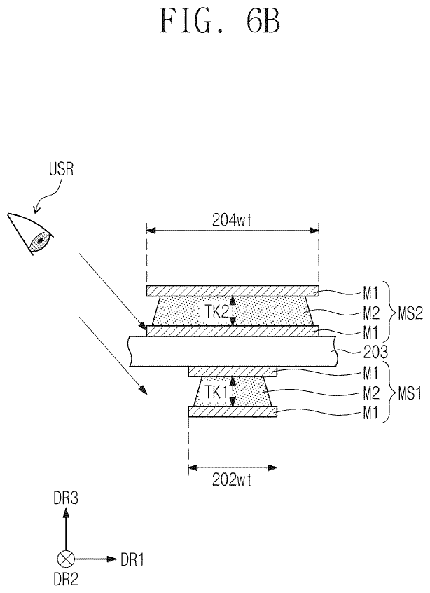

FIG. 6A is a cross-sectional view of the display panel DP, according to one or more embodiments of the present disclosure.

Referring to FIG. 6A at least one buffer layer BFL is formed on a top surface of the base layer 110 (as used herein, “formed on” or “located on” may mean “above”). The buffer layer BFL may improve a bonding force between the base layer 110 and a semiconductor pattern. The buffer layer BFL may be formed in multiple layers. Alternatively, the display layer 100 may further include a barrier layer. The buffer layer BFL may include at least one of silicon oxide, silicon nitride, or silicon oxynitride. For example, the buffer layer BFL may include a structure in which a silicon oxide layer and a silicon nitride layer are alternately stacked.

Semiconductor patterns SC, AL, DR, and SCL may be located on the buffer layer BFL. The semiconductor patterns SC, AL, DR, and SCL may include polysilicon. However, the present disclosure is not limited thereto, and the semiconductor patterns SC, AL, DR, and SCL may include amorphous silicon, low-temperature polycrystalline silicon, or an oxide semiconductor.

FIG. 6A only partially illustrates the semiconductor patterns SC, AL, DR, and SCL, and the semiconductor patterns are further located in another region. The semiconductor patterns SC, AL, DR, and SCL may be arranged in a corresponding rule across pixels. The semiconductor patterns SC, AL, DR, and SCL may have a different electrical properties, depending on doping states. The semiconductor patterns SC, AL, DR, and SCL may include the first regions SC, DR, and SCL having higher conductivity, and the second region AL having lower conductivity. The first regions SC, DR, and SCL may be doped with an N-type dopant or a P-type dopant. The P-type transistor may include a doped region doped with a P-type dopant, and the N-type transistor may include a doped region doped with an N-type dopant. The second region AL may be a non-doped region or a region doped at a lower concentration than the first regions SC, DR, and SCL.

The first regions SC, DR, and SCL may have conductivity higher than the conductivity of the second region AL, and may substantially serve as an electrode or a signal line. The second region AL may substantially correspond to an active region AL (or a channel) of a transistor 100PC. In other words, first portion (see reference numeral AL) among the semiconductor patterns SC, AL, DR, and SCL may be the active region AL of the transistor 100PC, and second portions among the semiconductor patterns SC, AL, DR, and SCL may be the source region SC or the drain region DR of the transistor 100PC. A third portion (see reference numeral SCL) among the semiconductor patterns SC, AL, DR, and SCL may be a connection electrode or the connection signal line SCL.

Each of pixels may have an equivalent circuit including a plurality of transistors, at least one capacitor, and at least one light-emitting element, and the equivalent circuit of the pixel may be modified in various forms. FIG. 6A illustrates that the pixel includes one transistor 100PC and one light-emitting element 100PE, by way of example.

The source region SC, the active region AL, and the drain region DR of the transistor 100PC may be formed from the semiconductor patterns SC, AL, DR, and SCL. The source region SC and the drain region DR may extend in directions opposite to each other from the active region AL, when viewed in a cross-sectional view. FIG. 6A illustrates a portion of the connection signal line SCL formed from the semiconductor patterns SC, AL, DR, and SCL. In one or more embodiments, the connection signal line SCL may be connected to the drain region DR of the transistor 100PC, when viewed in a plan view.

A first insulating layer 10 may be located on the buffer layer BFL. The first insulating layer 10 may be a common layer and may overlap with a plurality of pixels to cover the semiconductor patterns SC, AL, DR, and SCL The first insulating layer 10 may be an inorganic layer and/or an organic layer, and may have a single-layer structure or a multi-layer structure. The first insulating layer 10 may include at least one of an aluminum oxide, a titanium oxide, a silicon oxide, a silicon nitride, a silicon oxynitride, a zirconium oxide, or hafnium oxide. The first insulating layer 10 may be a silicon oxide layer in a single layer. The insulating layer of the circuit layer 120, which is to be described below, in addition to the first insulating layer 10, may be an inorganic layer and/or an organic layer, and may have a single-layer structure or a multi-layer structure. The inorganic layer may include, but is not limited to, at least one of the above-described materials.

A gate GT of the transistor 100PC is located on the first insulating layer 10. The gate GT may be a portion of a metal pattern. The gate GT overlaps the active region AL. In the process for doping or reducing the semiconductor patterns SC, AL, DR, and SCL, the gate GT may serve as a mask.

A second insulating layer 20 may be located on the first insulating layer 10 to cover the gate GT. The second insulating layer 20 may be commonly overlapped with the pixels. The second insulating layer 20 may be an inorganic layer and/or an organic layer, and may have a single-layer or multi-layer structure. The second insulating layer 20 may include at least one of silicon oxide, silicon nitride, or silicon oxynitride. The second insulating layer 20 may have a multi-layer structure including a silicon oxide layer and a silicon nitride layer.

A third insulating layer 30 may be located on the second insulating layer 20. The third insulating layer 30 may have a single-layer structure or a multi-layer structure. For example, the third insulating layer 30 may have a multi-layer structure including a silicon oxide layer and a silicon nitride layer.

A first connection electrode CNE1 may be located on the third insulating layer 30. The first connection electrode CNE1 may be connected to the connection signal line SCL through a contact hole CNT-1 formed through the first insulating layer 10, the second insulating layer 20, and the third insulating layer 30.

A fourth insulating layer 40 may be located on the third insulating layer 30. The fourth insulating layer 40 may be a silicon oxide layer in a single layer. A fifth insulating layer 50 may be located on the fourth insulating layer 40. The fifth insulating layer 50 may be an organic layer.

A second connection electrode CNE2 may be located on the fifth insulating layer 50. The second connection electrode CNE2 may be connected to the first connection electrode CNE1 through a contact hole CNT-2 formed through the fourth insulating layer 40, and the fifth insulating layer 50.

A sixth insulating layer 60 may be located on the fifth insulating layer 50 and may cover the second connection electrode CNE2. The sixth insulating layer 60 may be an organic layer.

The light-emitting element layer 130 may be located on the circuit layer 120. The light-emitting element layer 130 may include the light-emitting element 100PE. For example, the light-emitting element layer 130 may include an organic light-emitting material, an inorganic light-emitting material, an organic-inorganic light-emitting material, a quantum dot, a quantum rod, a micro-LED, or a nano-LED. The following description will be described regarding the light-emitting element 100PE that is an organic light-emitting element, by way of example, but the present disclosure is not specifically limited thereto.

The light-emitting element 100PE may include a first electrode AE, a light-emitting layer EL, and a second electrode CE.

The first electrode AE may be located on the sixth insulating layer 60. The first electrode AE may be connected with the second connection electrode CNE2 through a contact hole CNT-3 formed through the sixth insulating layer 60.

A pixel-defining layer 70 may be located on the sixth insulating layer 60 and may cover a portion of the first electrode AE. An opening 70-OP is defined in the pixel-defining layer 70. The opening 70-OP of the pixel-defining layer 70 exposes at least a portion of the first electrode AE.

The first display unit DA1-F (see FIG. 1A) may include a light-emitting region PXA and a non-light-emitting region NPXA adjacent to the light-emitting region PXA. The non-light-emitting region NPXA may surround the light-emitting region PXA. According to one or more embodiments, the light-emitting region PXA is defined to correspond to a portion of the first electrode AE, which is exposed by the opening 70-OP.

The light-emitting layer EL may be located on the first electrode AE. The light-emitting layer EL may be located in a region defined by the opening 70-OP. Although FIG. 6A illustrates that the light-emitting layer EL is located in the opening 70-OP, the present disclosure is not limited thereto. For example, the light-emitting layer EL may extend to cover a side surface of the pixel-defining layer 70 and a portion of the top surface of the pixel-defining layer 70, which define the opening 70-OP.

According to one or more embodiments of the present disclosure, the light-emitting layer EL may be separately formed with respect to pixels. When the light-emitting layer EL is separately formed with respect to the pixels, each of light-emitting layers EL may emit light of at least one of a blue color, a red color, or a green color. However, the present disclosure is not limited thereto. The light-emitting layer EL may have an integral form, and may be included in the plurality of pixels in common. In this case, the light-emitting layer EL may provide blue light or white light.

The second electrode CE may be located on the light-emitting layer EL. The second electrode CE may have an integral-type form, and may be located in the plurality of pixels in common.

According to one or more embodiments of the present disclosure, a hole control layer may be located in the first electrode AE and the light-emitting layer EL. The hole control layer may be located in the light-emitting region PXA and the non-light-emitting region NPXA in common. The hole control layer may further include a hole transfer layer and a hole injection layer. An electron control layer may be interposed between the light-emitting layer EL and the second electrode CE. The electron control layer may include an electron transfer layer and may further include an electron injection layer. The hole control layer and the electron control layer may be formed in the plurality of pixels in common by using an open mask or an ink-jet process.

The encapsulation layer 140 may be located on the light-emitting element layer 130. The encapsulation layer 140 may include an inorganic layer, an organic layer, and an inorganic layer sequentially stacked, and layers constituting the encapsulation layer 140 are not limited thereto. The inorganic layers may protect the light-emitting element layer 130 from moisture and oxygen, and the organic layer may protect the light-emitting element layer 130 from a foreign material, such as dust particles. The inorganic layers may include a silicon nitride layer, a silicon oxynitride layer, a silicon oxide layer, a titanium oxide layer, or an aluminum oxide layer. The organic layer may include an acrylic-based organic layer, but the present disclosure is not limited thereto.

The sensor layer 200 may include a base layer 201, a first conductive layer 202, an intermediate insulating layer 203, a second conductive layer 204, and a cover insulating layer 205.

The base layer 201 may be an inorganic layer including at least one of silicon nitride, silicon oxynitride, or silicon oxide. Alternatively, the base layer 201 may be an organic layer including an epoxy resin, an acrylic resin, or an imide-based resin. The base layer 201 may have a single-layer structure or a multi-layer structure including layers stacked in the third direction DR3. According to one or more embodiments of the present disclosure, the sensor layer 200 may not include the base layer 201.

Each of the first conductive layer 202 and the second conductive layer 204 may have a single-layer structure or a multi-layer structure including the layers stacked in the third direction DR3.

Each of the first conductive layer 202 and the second conductive layer 204 having a single-layer structure may include a metal layer or a transparent conductive layer. The metal layer may include molybdenum, silver, titanium, copper, aluminum, or an alloy thereof. The transparent conductive layer may include a transparent conductive oxide, such as indium tin oxide (ITO), indium zinc oxide (IZO), zinc oxide (ZnO), or indium zinc tin oxide (IZTO). In addition, the transparent conductive layer may include a conductive polymer, such as poly(3,4-ethylenedioxythiophene) (PEDOT), metal nanowires, or graphene.

Each of the first conductive layer 202 and the second conductive layer 204 having a multi-layer structure may include metal layers. The metal layers may have, for example, a three-layer structure of titanium/aluminum/titanium. The conductive layer in the multi-layer structure may include at least one metal layer and at least one transparent conductive layer.

According to one or more embodiments of the present disclosure, the thickness of the first conductive layer 202 may be greater than or equal to the thickness of the second conductive layer 204. When the thickness of the first conductive layer 202 is greater than the thickness of the second conductive layer 204, the resistance of components (e.g., an electrode, a sensing pattern, or a bridge pattern) included in the first conductive layer 202 may be reduced. In addition, because the first conductive layer 202 is located below the second conductive layer 204, even if the thickness of the first conductive layer 202 is increased, the probability that components included in the first conductive layer 202 are viewed by external light reflection, may be lower than that of the second conductive layer 204.

At least one of the intermediate insulating layer 203 or the cover insulating layer 205 may include an inorganic film. The inorganic film may include at least one of an aluminum oxide, a titanium oxide, a silicon oxide, a silicon nitride, a silicon oxynitride, a zirconium oxide, or hafnium oxide.

At least one of the intermediate insulating layer 203 or the cover insulating layer 205 may include an organic film. The organic film may include at least one of an acrylic resin, a methacryl resin, polyisoprene, a vinyl resin, an epoxy resin, a urethane resin, a cellulose resin, a siloxane resin, a polyimide resin, a polyamide resin, or a perylene resin.

Although the above-description has been made regarding that the total of two conductive layers of the first conductive layer 202 and the second conductive layer 204 are provided, the present disclosure is not limited thereto. For example, the sensor layer 200 may include at least three conductive layers.

FIG. 6B is a cross-sectional view illustrating the sensor layer 200, according to one or more embodiments of the present disclosure.

Referring to FIGS. 6A and 6B, a second width 204wt of a second mesh line MS2 included in the second conductive layer 204 may be equal to or greater than a first width 202wt of a first mesh line MS1 included in the first conductive layer 202. When a user USR views the first mesh line MS1 and the second mesh line MS2 from the side, because the first mesh line MS1 has a smaller width than the second mesh line MS2, the probability that the first mesh line MS1 is viewed by the user USR may be reduced.

Each of the first mesh line MS1 and the second mesh line MS2 may include first metal layers M1, and a second metal layer M2 interposed between the first metal layers M1. For example, the first metal layers M1 may include titanium (Ti), and the second metal layer M2 may include aluminum (Al). However, the present disclosure is not specifically limited thereto.

According to one or more embodiments of the present disclosure, a first thickness TK1 of the second metal layer M2 of the first mesh line MS1 may be substantially equal to a second thickness TK2 of the second metal layer M2 of the second mesh line MS2, but the present disclosure is not particularly limited thereto. For example, the first thickness TK1 may be thicker than the second thickness TK2. Alternatively, the second thickness TK2 may be thicker than the first thickness TK1. According to one or more embodiments of the present disclosure, each of the first thickness TK1 and the second thickness TK2 may be 1000 angstroms or more, for example, 6000 angstroms.

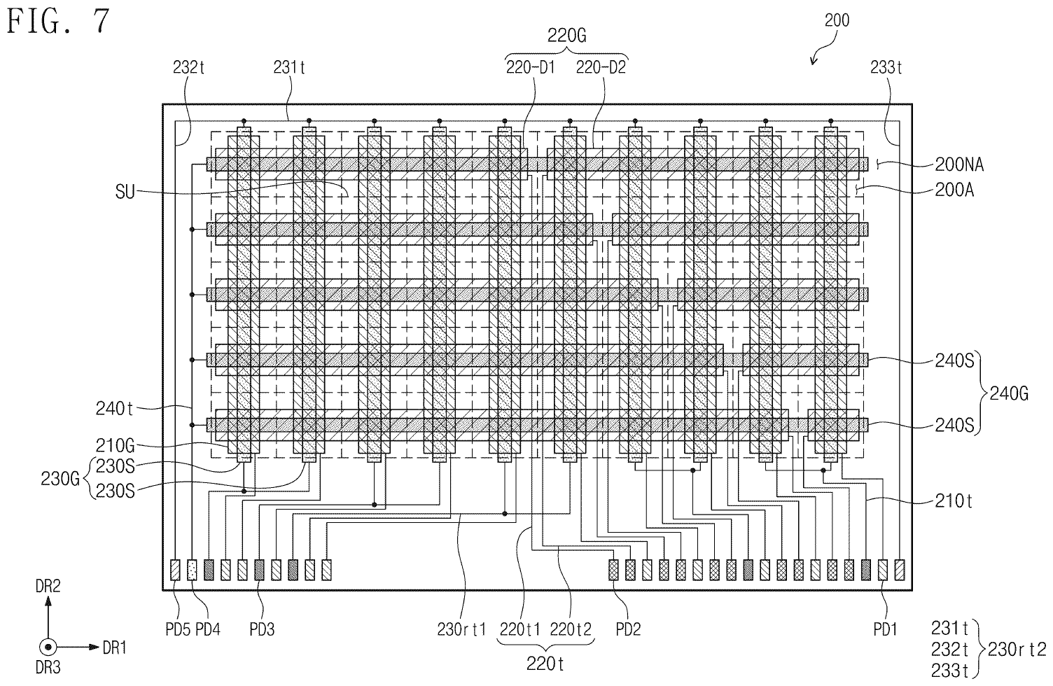

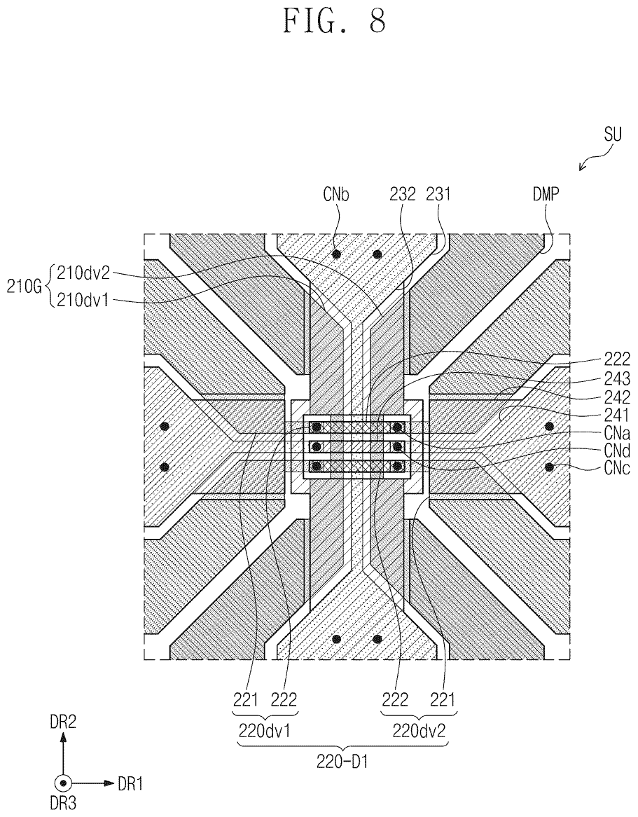

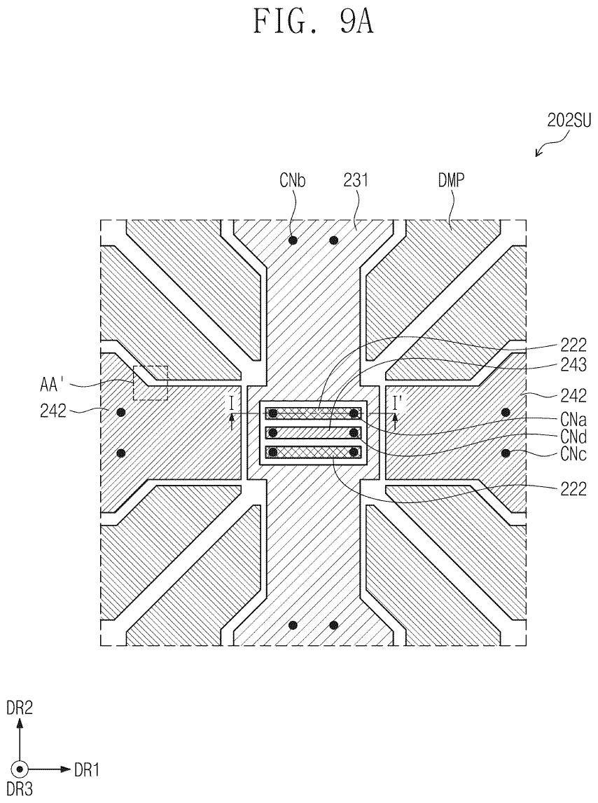

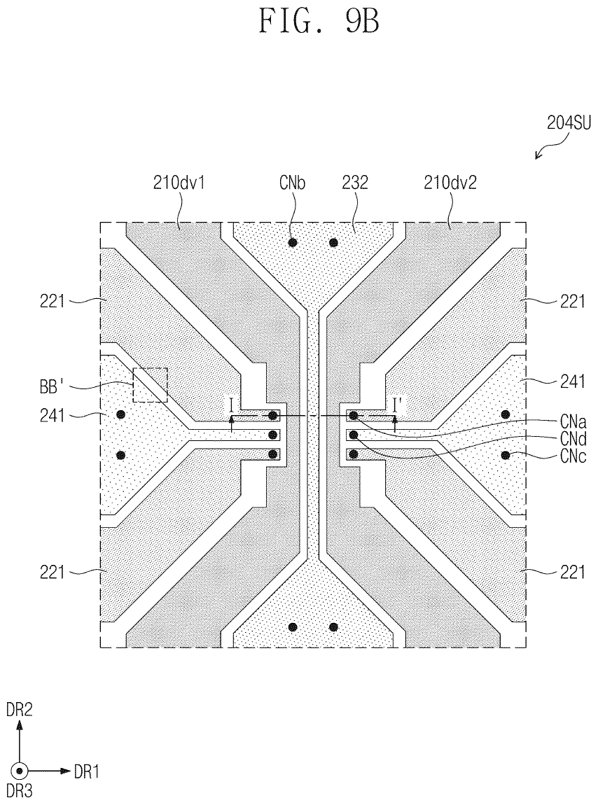

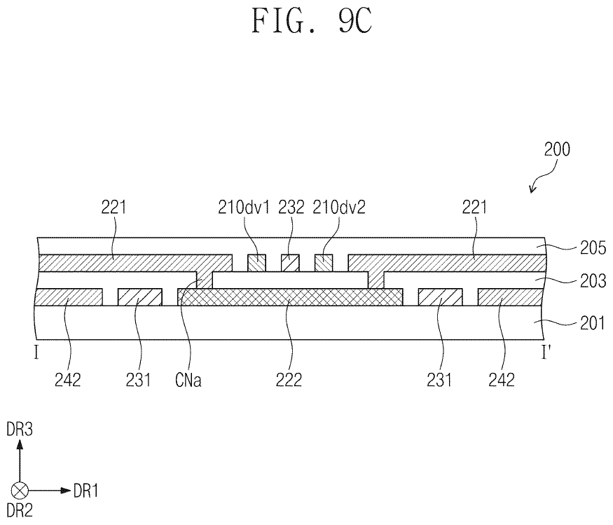

FIG. 7 is a cross-sectional view illustrating the sensor layer 200, according to one or more embodiments of the present disclosure. FIG. 8 is an enlarged plan view illustrating a sensing unit SU according to one or more embodiments of the present disclosure. FIG. 9A is a plan view illustrating a first conductive layer 202SU of the sensing unit SU according to one or more embodiments of the present disclosure. FIG. 9B is a plan view illustrating a second conductive layer 204SU of the sensing unit SU according to one or more embodiments of the present disclosure. FIG. 9C is a cross-sectional view of the sensor layer 200 according to one or more embodiments of the present disclosure, which is taken along the line I-I′ shown in FIGS. 9A and 9B, respectively.

Referring to FIG. 7, the sensor layer 200 may include the sensing region 200A, and the peripheral region 200NA adjacent to the sensing region 200A.

The sensor layer 200 may include a plurality of first electrode groups 210G, a plurality of second electrode groups 220G, a plurality of third electrode groups 230G, and a fourth electrode group 240G located in the sensing region 200A.

The first electrode groups 210G may cross the second electrode groups 220G, respectively. The first electrode groups 210G may extend in the second direction DR2, and may be arranged to be spaced apart from each other in the first direction DR1. The second electrode groups 220G may extend in the first direction DR1, and may be arranged to be spaced apart from each other in the second direction DR2. The sensing unit SU of the sensor layer 200 may be a region in which one first electrode group 210G crosses one second electrode group 220G.

As illustrated in FIG. 7, 10 first electrode groups 210G and five second electrode groups 220G are provided, and 50 sensing units SU are provided, but the number of first electrode groups 210G and the number of second electrode groups 220G are not limited thereto.

According to one or more embodiments of the present disclosure, each of the second electrode groups 220G may include a first divided electrode 220-D1 and a second divided electrode 220-D2. The first divided electrode 220-D1 and the second divided electrode 220-D2 may be spaced apart from each other in the first direction DR1. Each of the first divided electrode 220-D1 and the second divided electrode 220-D2 may extend in the first direction DR1. The first divided electrode 220-D1 and the second divided electrode 220-D2 included in one second electrode group 220G may sense along the same axis (for example, an axis extending in the first direction DR1).

Referring to FIGS. 7 and 8, each of the first electrode groups 210G may include first divided electrodes 210dv1 and 210dv2. The first divided electrodes 210dv1 and 210dv2 may extend in the second direction DR2, and may be spaced apart from each other in the first direction DR1. The first divided electrodes 210dv1 and 210dv2 may have a symmetrical shape about a line extending in the second direction DR2.

Each of the first divided electrode 220-D1 and the second divided electrode 220-D2 may include second unit divided electrodes 220dv1 and 220dv2. The second unit divided electrodes 220dv1 and 220dv2 extend in the first direction DR1 and may be spaced apart from each other in the second direction DR2. The second unit divided electrodes 220dv1 and 220dv2 may have linear symmetrical shapes about a line extending in the first direction DR1.

Referring to FIGS. 8, 9A, 9B, and 9C, each of the second unit divided electrodes 220dv1 and 220dv2 may include a sensing pattern 221 and a bridge pattern 222. The sensing pattern 221 and the bridge pattern 222 are located in different layers, and the sensing pattern 221 and the bridge pattern 222 may be electrically connected to each other through a first contact CNa. For example, the bridge pattern 222 may be included in the first conductive layer 202SU, and the sensing pattern 221 and the first divided electrodes 210dv1 and 210dv2 may be included in the second conductive layer 204SU. The first conductive layer 202SU may be included in the first conductive layer 202 of FIG. 6A, and the second conductive layer 204SU may be included in the second conductive layer 204 of FIG. 6A.

Referring to FIG. 7, the third electrode groups 230G may be arranged to be spaced apart from each other in the first direction DR1. According to one or more embodiments of the present disclosure, the third electrode groups 230G may include a plurality of first auxiliary electrodes 230S that are electrically connected to each other. The number of first auxiliary electrodes 230S included in each of the third electrode groups 230G may be variously modified. For example, as the number of first auxiliary electrodes 230S included in each of the third electrode groups 230G increases, resistance of each of the third electrode groups 230G decreases, power efficiency may be improved, and sensing sensitivity may be improved. To the contrary, as the number of first auxiliary electrodes 230S included in each of the third electrode groups 230G decreases, a loop coil pattern formed by using the third electrode groups 230G may be implemented in more various forms.

Although FIG. 7 exemplarily illustrates which one third electrode group 230G includes two first auxiliary electrodes 230S, the present disclosure is not limited thereto. The first auxiliary electrodes 230S may be located in a one-to-one correspondence to the first electrode groups 210G. Accordingly, one sensing unit SU may include a portion of one first auxiliary electrode 230S.

A coupling capacitor may be defined between one first electrode group 210G and one first auxiliary electrode 230S. In this case, an induction current generated during pen sensing may be transferred from the first auxiliary electrode 230S to the first electrode group 210G through the coupling capacitor. In other words, the first auxiliary electrode 230S may serve to supplement the signal transmitted from the first electrode group 210G to the sensor driver 200C. Accordingly, when the signal induced to the first auxiliary electrode 230S is in phase with the signal induced to the first electrode group 210G, an improved or greatest effect may be obtained. Accordingly, the center of each of the first electrode groups 210G in the second direction DR2 may be aligned with the center of each of the first auxiliary electrodes 230S in the second direction DR2. In addition, the center of each of the first electrode groups 210G in the first direction DR1 may be aligned with the center of each of the first auxiliary electrodes 230S in the first direction DR1.

According to one or more embodiments of the present disclosure, because one third electrode group 230G includes two first auxiliary electrodes 230S, one third electrode group 230G may correspond to (or overlap) the two first electrode groups 210G. Accordingly, the number of first electrode groups 210G included in the sensor layer 200 may be greater than the number of third electrode groups 230G. For example, the number of first electrode groups 210G may be equal to the product of the number of third electrode groups 230G included in the sensor layer 200 and the number of first auxiliary electrodes 230S included in each of the third electrode groups 230G. In FIG. 7, the number of first electrode groups 210G is ‘10’, the number of third electrode groups 230G is ‘5’, and the number of first auxiliary electrodes 230S included in each of the third electrode groups 230G may be ‘2’.

The fourth electrode group 240G may include a plurality of second auxiliary electrodes 240S arranged in the second direction DR2. Each of the second auxiliary electrodes 240S may extend in the first direction DR1. According to one or more embodiments of the present disclosure, the second auxiliary electrodes 240S may be electrically connected to each other.

A coupling capacitor may be defined between one second electrode group 220G and one second auxiliary electrode 240S. In this case, an induction current generated during pen sensing may be transmitted from the second auxiliary electrode 240S to the second electrode group 220G through the coupling capacitor. In other words, the second auxiliary electrode 240S may serve to supplement a signal transmitted from the second electrode group 220G to the sensor driver 200C. Accordingly, when the signal induced to the second auxiliary electrode 240S is in phase with the signal induced to the second electrode group 220G, an improved or greatest effect may be produced. Accordingly, the center of each of the second electrode groups 220G in the first direction DR1 may be aligned with the center of each of the second auxiliary electrode 240S in the first direction DR1. In addition, the center of each of the second electrode groups 220G in the second direction DR2 may be aligned with the center of each of the second auxiliary electrode 240S in the second direction DR2.

Referring to FIGS. 7, 9A, and 9B, each of the first auxiliary electrodes 230S included in the third electrode group 230G may include a (3-1)-th pattern 231 and a (3-2)-th pattern 232. The (3-1)-th pattern 231 and the (3-2)-th pattern 232 are located in different layers, and may be electrically connected to each other through a second contact CNb. The (3-1)-th pattern 231 may be included in the first conductive layer 202SU, and the (3-2)-th pattern 232 may be included in the second conductive layer 204SU.

According to one or more embodiments of the present disclosure, a portion of the (3-1)-th pattern 231 may overlap a portion of each of the first divided electrodes 210dv1 and 210dv2. Accordingly, a coupling capacitor may be provided (or formed) between the first electrode group 210G and the third electrode group 230G.

Referring to FIGS. 7, 9A, and 9B, each of the second auxiliary electrodes 240S included in the fourth electrode group 240G may include a (4-1)-th pattern 241, a (4-2)-th pattern 242, and a (4-3)-th pattern 243. The (4-2)-th pattern 242 and the (4-3)-th pattern 243 may be located in the same layer, and the (4-1)-th pattern 241 may be located in a different layer from the (4-2)-th pattern 242 and the (4-3)-th pattern 243. The (4-1)-th pattern 241 and the (4-2)-th pattern 242 may be electrically connected to each other through a third contact CNc, and the (4-1)-th pattern 241 and the (4-3)-th pattern 243 may be electrically connected to each other through a fourth contact CNd. The (4-2)-th pattern 242 and the (4-3)-th pattern 243 may be included in the first conductive layer 202SU, and the (4-1)-th pattern 241 may be included in the second conductive layer 204SU.

According to one or more embodiments of the present disclosure, a portion of the (4-2)-th pattern 242 may overlap the sensing pattern 221 of each of the second unit divided electrodes 220dv1 and 220dv2. Accordingly, a coupling capacitor may be defined (or provided or formed) between the second electrode group 220G and the fourth electrode group 240G.

According to one or more embodiments of the present disclosure, the first conductive layer 202SU may further include dummy patterns DMP. Each of the dummy patterns DMP may be electrically floated or electrically grounded. According to one or more embodiments of the present disclosure, the dummy patterns DMP may be omitted. Because the dummy patterns DMP are located in the empty space, the probability that patterns are viewed by external light reflection may be reduced.

The sensor layer 200 may further include a plurality of first pads PD1 connected in one-to-one correspondence to a plurality of first trace lines 210t located in the peripheral region 200NA. The first trace lines 210t may be electrically connected in one-to-one correspondence to the first electrode groups 210G. In other words, one first trace line 210t may be connected to one first electrode group 210G.

The sensor layer 200 may further include a plurality of second trace lines 220t at least partially overlapped with the sensing region 200A, and a plurality of second pads PD2 connected in one-to-one correspondence to the plurality of second trace lines 220t. The second trace lines 220t may overlap the first electrode groups 210G and the second electrode groups 220G, or may be insulated from the first electrode groups 210G and the second electrode groups 220G while crossing the first electrode groups 210G and the second electrode groups 220G. Accordingly, the area of the peripheral region 200NA may be reduced. Accordingly, the area occupied by the peripheral region 200NA on the front surface of the electronic device 1000 (see FIG. 1A) may be reduced, and a narrower bezel may be implemented.

The first trace lines 210t may be electrically connected in a one-to-one correspondence to the first electrode groups 210G. The two first divided electrodes 210dv1 and 210dv2 included in one first electrode group 210G may be connected to one of the first trace lines 210t. Each of the first trace lines 210t may include a plurality of branches to be connected to the two first divided electrodes 210dv1 and 210dv2. According to one or more embodiments of the present disclosure, the two first divided electrodes 210dv1 and 210dv2 may be connected to each other in the sensing region 200A.

The second trace lines 220t may be electrically connected to the second electrode groups 220G in a 2:1 correspondence to the second electrode groups 220G. Because the second trace lines 220t are electrically connected to the second electrode groups 220G in the 2:1 correspondence, the number of second trace lines 220t may be two times the number of second electrode groups 220G. In other words, two second trace lines 220t1 and 220t2 may be electrically connected to one second electrode group 220G.

One of the second trace lines 220t1 and 220t2 may be referred to as the (2-1)-th trace line 220t1, and a remaining one of the second trace lines 220t1 or 220t2 may be referred to as the (2-2)-th trace line 220t2. The (2-1)-th trace line 220t1 may be electrically connected to the first divided electrode 220-D1, and the (2-2)-th trace line 220t2 may be electrically connected to the second divided electrode 220-D2.

At least a portion of each of the (2-1)-th trace line 220t1 and the (2-2)-th trace line 220t2 may overlap the display region 100A (see FIG. 4). For example, when viewed in a plan view, the shape or the area of the display region 100A may be similar to the shape or the area of the sensing region 200A.

According to one or more embodiments of the present disclosure, the (2-1)-th trace line 220t1 and the (2-2)-th trace line 220t2 electrically connected to one second electrode group 220G may have substantially equal lengths in the second direction DR2. For example, a portion of the (2-1)-th trace line 220t1 overlapped with the sensing region 200A may have a length substantially equal to a length of a portion of the (2-2)-th trace line 220t2 overlapped with the sensing region 200A.

According to one or more embodiments of the present disclosure, because the second trace lines 220t overlap the sensing region 200A, the second trace lines 220t may be spread more widely in the sensing region 200A than the peripheral region 200NA. Accordingly, mutual inductances between the pen PN and the second trace lines 220t may vary depending on the position of the pen PN (see FIG. 5).

According to one or more embodiments of the present disclosure, the sensor driver 200C (refer to FIG. 5) may perform a primary differential sensing operation with respect to a signal provided from the (2-1)-th trace line 220t1 and a signal provided from the (2-2)-th trace line 220t2 before differentially sensing signals received from two different second electrode groups. Mutual inductances of the (2-1)-th trace line 220t1 and the (2-2)-th trace line 220t2 affecting the distortion of coordinates may be removed through the primary differential sensing operation. Accordingly, the coordinate accuracy sensed by the sensor layer 200 and the sensor driver 200C may be improved.

The (2-1)-th trace line 220t1 may be connected to one region of the first divided electrode 220-D1 adjacent to the second divided electrode 220-D2, and the (2-2)-th trace line 220t2 may be connected to one region of the second divided electrode 220-D2 adjacent to the first divided electrode 220-D1. For example, each of the (2-1)-th trace line 220t1 and the (2-2)-th trace line 220t2 may extend from a region adjacent to the gap between the first divided electrode 220-D1 and the second divided electrode 220-D2.

The sensor layer 200 may further include third trace lines 230rt1 located in the peripheral region 200NA, third pads PD3 connected in one-to-one correspondence to the third trace lines 230rt1, a fourth trace line 240t, a fourth pad PD4 connected to the fourth trace line 240t, a fifth trace line 230rt2, and fifth pads PD5 connected to one end and an opposite of the fifth trace line 230rt2.

The third trace lines 230rt1 may be connected in a one-to-one correspondence to the third electrode groups 230G, respectively. In other words, the number of third trace lines 230rt1 may correspond to the number of third electrode groups 230G. In FIG. 7, five third trace lines 230rt1 are illustrated.

According to one or more embodiments of the present disclosure, the third trace lines 230rt1 and the third pad PD3 may be omitted, or a charging driving mode for charging the pen may be omitted. In this case, the sensor layer 200 may sense an input made by an active-type pen, which is able to emit a magnetic field, even though a magnetic field is not provided from the sensor layer 200.

The fourth trace line 240t may be electrically connected to the second auxiliary electrodes 240S.

The fifth trace line 230rt2 may be electrically connected to at least one first auxiliary electrode 230S of the first auxiliary electrodes 230S. According to one or more embodiments of the present disclosure, the fifth trace line 230rt2 may be electrically connected to all of the first auxiliary electrodes 230S. In other words, the fifth trace line 230rt2 may be electrically connected to all of the third electrode groups 230G. The fifth trace line 230rt2 may include a first line portion 231t extending in the first direction DR1 and electrically connected to the third electrode groups 230G, a second line portion 232t extending in the second direction DR2 from a first end portion of the first line portion 231t, and a third line portion 233t extending in the second direction DR2 from a second end portion of the first line portion 231t.

According to one or more embodiments of the present disclosure, each of the resistance of the second line portion 232t and the resistance of the third line portion 233t may be substantially equal to the resistance of one third electrode group of the third electrode groups 230G. Accordingly, the second line portion 232t and the third line portion 233t may function as the third electrode groups 230G, thereby producing an effect the same as an effect produced when the third electrode groups 230G are located in the peripheral region. For example, any one of the second line portion 232t or the third line portion 233t and any one of the third electrode groups 230G may form a coil. Accordingly, even a pen positioned in a region adjacent to the peripheral region 200NA may be sufficiently charged by a loop including the second line portion 232t or the third line portion 233t.

According to one or more embodiments of the present disclosure, to adjust the resistance of the second line portion 232t and the resistance of the third line portion 233t, the width of each of the second line portion 232t and the third line portion 233t in the first direction DR1 may be adjusted. However, this is provided only for the illustrative purpose. For example, the first to third line portions 231t, 232t, and 233t may have substantially equal widths.

Referring to FIGS. 9A and 9B, areas occupied by components included in the first electrode group 210G and the second electrode group 220G in the second conductive layer 204SU in one sensing unit SU may be wider than areas occupied by components included in the third electrode group 230G and the fourth electrode group 240G. A change in capacitance by the first input 2000 (see FIG. 4) may increase as the distance of the first input 2000 decreases. Accordingly, a component to sense the first input 2000 (see FIG. 4) may be located while occupying a larger area in a layer adjacent to the surface of the electronic device 1000 (see FIG. 1A). Accordingly, touch performance may be improved.

FIGS. 7 to 9C illustrate the structure in which each of the first to fourth electrode groups 210G, 220G, 230G, and 240G is divided and respectively located in two conductive layers 202SU and 204SU, but the present disclosure is not particularly limited thereto. For example, the first to fourth electrode groups 210G, 220G, 230G, and 240G may be divided to be arranged in three conductive layers or in four conductive layers.

According to one or more embodiments of the present disclosure, the third electrode groups 230G receiving the signal in the charging driving mode may be included in a third conductive layer located under the first and second conductive layers 202SU and 204SU. For example, the third conductive layer may be provided under the base layer 201. The third conductive layer may be located between the base layer 201 and the display layer 100, may be located under the display layer 100, or may be included in the display layer 100.

The first, second, and fourth electrode groups 210G, 220G, and 240G may be included in the first and second conductive layers 202SU and 204SU. For example, when the third electrode groups 230G are implemented in the form of a separate conductive layer, such as the third conductive layer, the shapes of the third electrode groups 230G may be more freely designed. For example, the third electrode groups 230G may be provided in a form including a plurality of coils. In addition, the third electrode groups 230G may be provided more densely using the third conductive layer. In this case, pen-sensing sensitivity may be improved. According to one or more embodiments of the present disclosure, the third conductive layer may include the fourth electrode group 240G instead of the third electrode groups 230G.

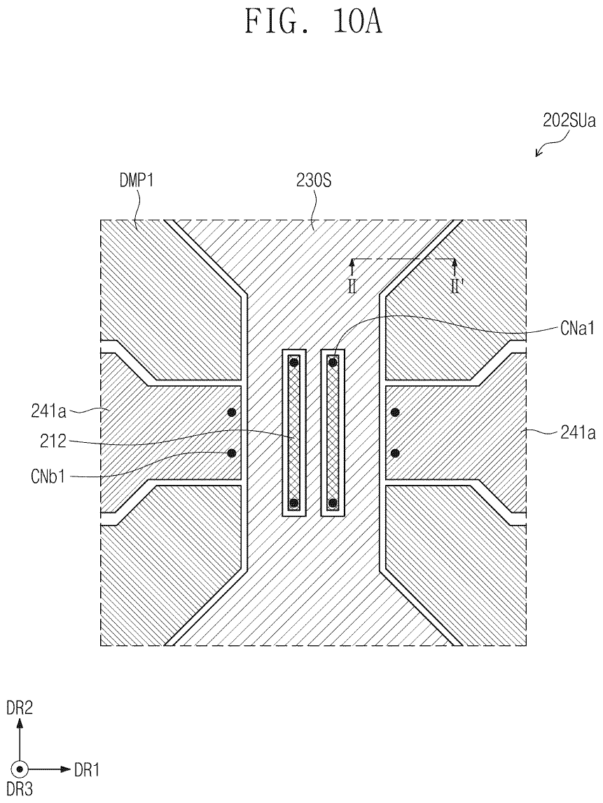

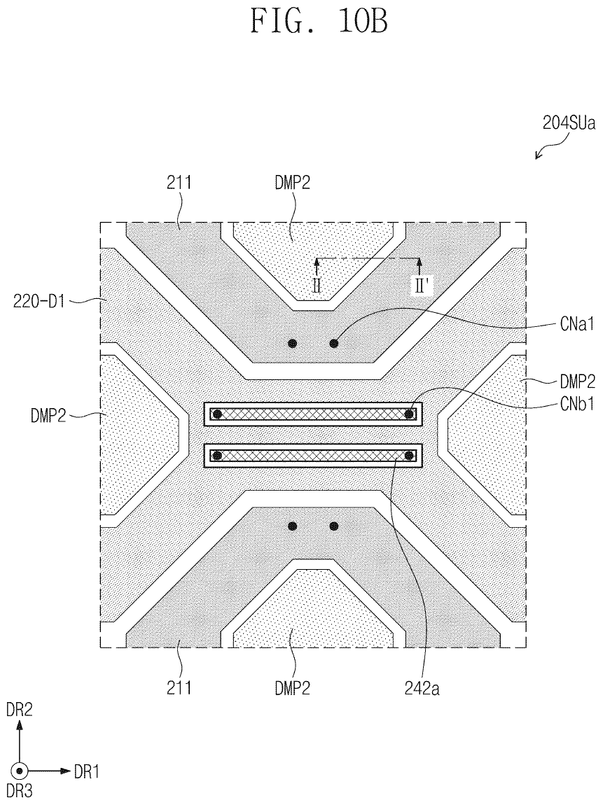

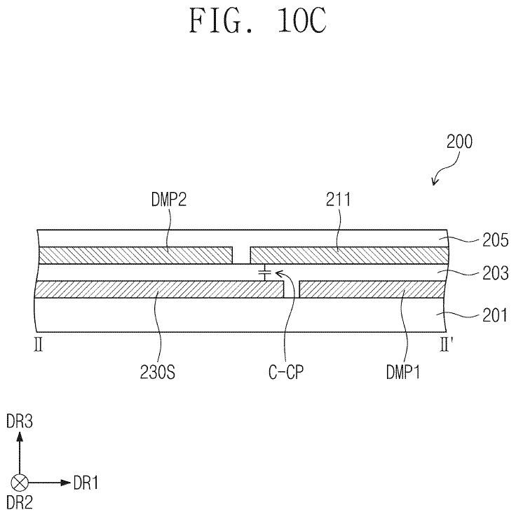

FIG. 10A is a plan view illustrating a first conductive layer 202SUa of a sensing unit according to one or more embodiments of the present disclosure. FIG. 10B is a plan view illustrating a second conductive layer 204SUa of a sensing unit according to one or more embodiments of the present disclosure. FIG. 10C is a cross-sectional view of a sensor layer taken along the line II-II′ of FIGS. 10A and 10B, respectively.

Referring to FIGS. 8, 10A, 10B, and 10C, each of the first electrode groups 210G may include a plurality of first sensing patterns 211 and a plurality of first bridge patterns 212. The first sensing patterns 211 are spaced apart from each other in the second direction DR2, and the first bridge patterns 212 may extend in the second direction DR2, and may be electrically connected to the first sensing patterns 211 through a first contact CNa1. Although FIGS. 10A and 10B illustrate that two adjacent first sensing patterns 211 are electrically connected to each other through two first bridge patterns 212, but the present disclosure is not limited thereto. For example, the two adjacent first sensing patterns 211 may be electrically connected to each other through one first bridge pattern 212, or may be electrically connected to each other through three or more first bridge patterns 212.

FIG. 10B illustrates the first divided electrode 220-D1 among the first divided electrode 220-D1 and the second divided electrode 220-D2. The first sensing patterns 211 adjacent to each other in the second direction DR2 may be spaced apart from each other while interposing the first divided electrode 220-D1 between the first sensing patterns 211. According to one or more embodiments of the present disclosure, the first sensing patterns 211, the first divided electrode 220-D1, and the second divided electrode 220-D2 may be included in a second conductive layer 204SUa, and the first bridge patterns 212 may be included in a first conductive layer 202SUa. The first bridge patterns 212 may insulate and cross the first divided electrode 220-D1 or the second divided electrode 220-D2 while overlapping the first divided electrode 220-D1 or the second divided electrode 220-D2.

Each of the first auxiliary electrodes 230S included in the third electrode group 230G may extend in the second direction DR2. The first auxiliary electrodes 230S may be included in the first conductive layer 202SUa. One or more holes may be defined in each of the first auxiliary electrodes 230S. One first bridge pattern 212 may be located in one hole. Accordingly, the first bridge pattern 212 may be electrically insulated from the first auxiliary electrodes 230S.

Each of the second auxiliary electrodes 240S included in the fourth electrode group 240G may include a plurality of second sensing patterns 241a and a plurality of second bridge patterns 242a. The second sensing patterns 241a are spaced apart in the first direction DR1, and the second bridge patterns 242a may extend in the first direction DR1 to be electrically connected to the second sensing patterns 241a through a second contact CNb1.

Although FIGS. 10A and 10B illustrate which two adjacent second sensing patterns 241a are electrically connected to each other through two second bridge patterns 242a, the present disclosure is not limited thereto. For example, in one or more other embodiments, two adjacent second sensing patterns 241a may be electrically connected to each other through one second bridge pattern 242a, or may be electrically connected to each other through three or more second bridge patterns 242a.

According to one or more embodiments of the present disclosure, the second sensing patterns 241a and the first auxiliary electrodes 230S may be included in the first conductive layer 202SUa, and the second bridge patterns 242a may be included in the second conductive layer 204SUa. The second bridge patterns 242a may be insulated from the first auxiliary electrodes 230S overlapped with the second bridge patterns 242a while crossing the first auxiliary electrodes 230S overlapped with the second bridge patterns 242a.

Referring to FIGS. 10A and 10B, in the second conductive layer 204SU in one sensing unit SU, areas occupied by components included in the first electrode group 210G and the second electrode group 220G may be greater than areas occupied by components included in the third electrode group 230G and the fourth electrode group 240G. The change in capacitance due to the first input 2000 (see FIG. 4) may be greater, as the first input 2000 approaches. Accordingly, a component for sensing the first input 2000 (see FIG. 4) may be located with a relatively larger area in a layer adjacent to a surface of the electronic device 1000 (see FIG. 1A). Accordingly, touch performance may be improved.

According to one or more embodiments of the present disclosure, the first conductive layer 202SUa may further include first dummy patterns DMP1, and the second conductive layer 204SUa may further include second dummy patterns DMP2. Each of the first dummy patterns DMP1 and the second dummy patterns DMP2 may be floated or electrically floated. Each of the first dummy patterns DMP1 and the second dummy patterns DMP2 may be divided into a plurality of conductive patterns. For example, one first dummy pattern DMP1 may include a plurality of floating dummy patterns that are separated from each other or electrically isolated from each other.

Referring to FIG. 10C, the area of the first auxiliary electrode 230S and the area of the first sensing pattern 211 may be adjusted. For example, the position of the boundary between the first auxiliary electrode 230S and the first dummy patterns DMP1, and the position of the boundary between the first sensing pattern 211 and the second dummy patterns DMP2, may be adjusted. In this case, the area of the overlap region between the first auxiliary electrode 230S and the first sensing pattern 211 may be adjusted to adjust the capacitance size of a coupling capacitor C-CP between the first auxiliary electrode 230S and the first sensing pattern 211.

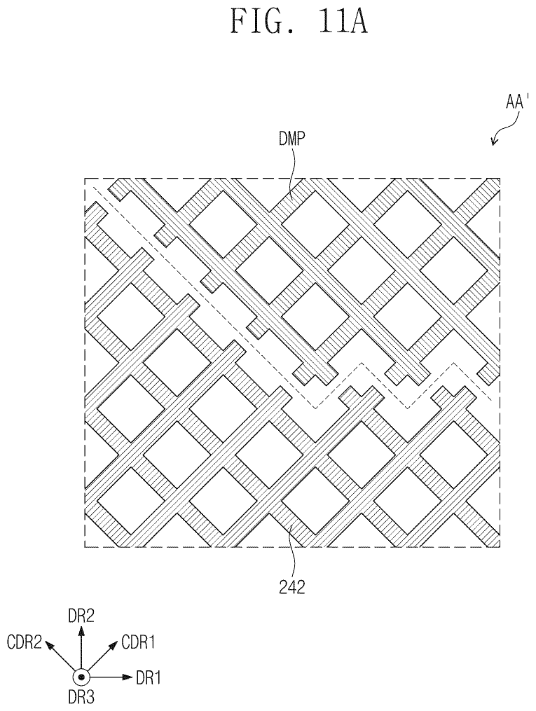

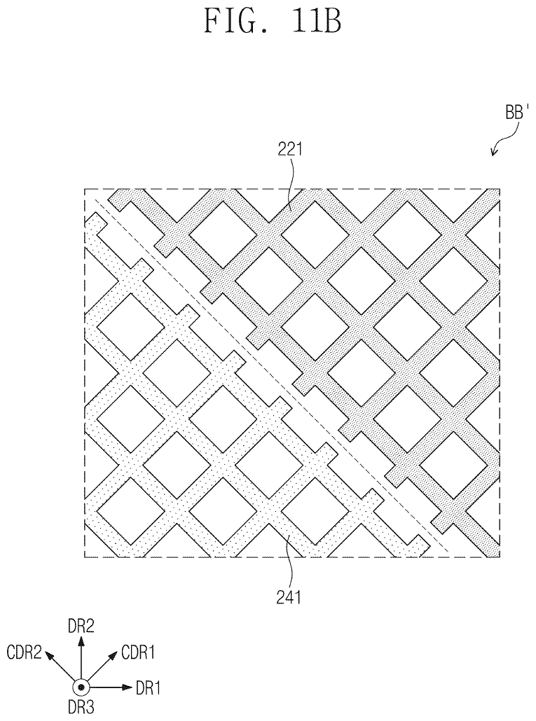

FIG. 11A is an enlarged plan view of region AA′ illustrated in FIG. 9A. FIG. 11B is an enlarged plan view of region BB′ illustrated in FIG. 9B.

Referring to FIGS. 9A, 9B, 11A, and 11B, each of the first electrode groups 210G, the second electrode groups 220G, the third electrode groups 230G, the fourth electrode groups 240G, and the dummy patterns DMP may have a mesh structure. Each of the mesh structures may include a plurality of mesh lines. Each of the plurality of mesh lines has a form extending in a corresponding direction and may be connected to each other. The form may have various forms, such as a straight line, a line having a protrusion, or a uneven line. Openings, in which a mesh structure is not located, may be defined (provided or formed) in each of the first electrode groups 210G, the second electrode groups 220G, the third electrode groups 230G, the fourth electrode groups 240G, and/or the dummy patterns DMP.

FIGS. 11A and 11B illustrate a mesh structure including mesh lines extending in a first crossing direction CDR1 crossing the first direction DR1 and the second direction DR2, and mesh lines extending in a second crossing direction CDR2 crossing the first crossing direction CDR1. However, the extending direction of the mesh lines constituting the mesh structure is not particularly limited to those illustrated in FIGS. 11A and 11B. For example, the mesh structure may include only mesh lines extending in the first direction DR1 and the second direction DR2, or may include mesh lines extending in the first direction DR1, the second direction DR2, the first crossing direction CDR1, and the second crossing direction CDR2. In other words, the mesh structure may be changed in various forms.

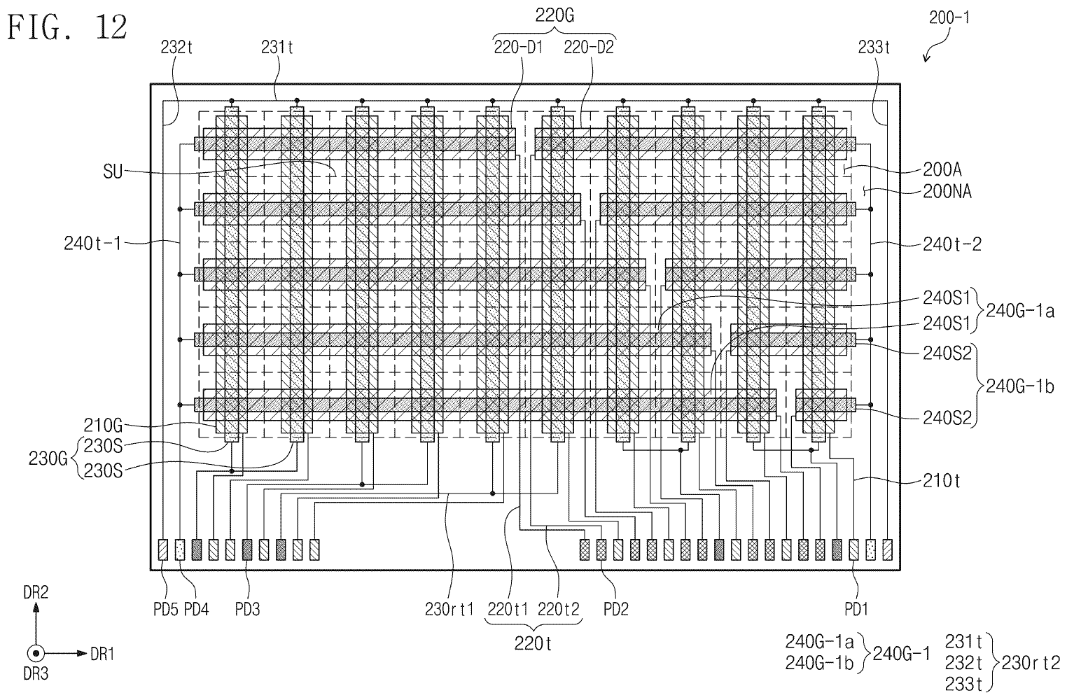

FIG. 12 is a plan view of a sensor layer 200-1 according to one or more embodiments of the present disclosure. In the following description with reference to FIG. 12, components described with reference to FIG. 7 are assigned with the same reference numerals, and the details thereof will be omitted.

Referring to FIG. 12, the sensor layer 200-1 may include the plurality of first electrode groups 210G, the plurality of second electrode groups 220G, the plurality of third electrode groups 230G, and a plurality of fourth electrode groups 240G-1 located in the sensing region 200A.

FIG. 12 illustrates two fourth electrode groups 240G-1 facing each other in the first direction DR1. The fourth electrode groups 240G-1 may include a (4-1)-th electrode group 240G-1a overlapped with the first divided electrodes 220-D1 of the second electrode groups 220G, and a (4-2)-th electrode group 240G-1b overlapped with the second divided electrodes 220-D2 of the second electrode groups 220G. The (4-1)-th electrode group 240G-1a includes a plurality of (2-1)-th auxiliary electrodes 240S1 arranged in the second direction DR2, and the (4-2)-th electrode group 240G-1b may include a plurality of (2-2)-th auxiliary electrodes 240S2 arranged in the second direction DR2.

The sensor layer 200-1 may further include fourth trace lines 240t-1 and 240t-2 located in the peripheral region 200NA. All of the (2-1)-th auxiliary electrodes 240S1 included in the (4-1)-th electrode group 240G-1a are electrically connected to the (4-1)-th trace lines 240t-1, and all of the (2-2)-th auxiliary electrodes 240S2 included in the (4-2)-th electrode group 240G-1b may be electrically connected to the (4-2)-th trace lines 240t-2.

According to one or more embodiments of the present disclosure, routing directions of the first divided electrodes 220-D1 and the (2-1)-th auxiliary electrodes 240S1 overlapped each other may be different from each other. In addition, the routing directions of the second divided electrodes 220-D2 and the (2-2)-th auxiliary electrodes 240S2 overlapped each other may be different from each other. The routing directions different from each other refers to the connection positions of the electrodes and the trace lines being different from each other.

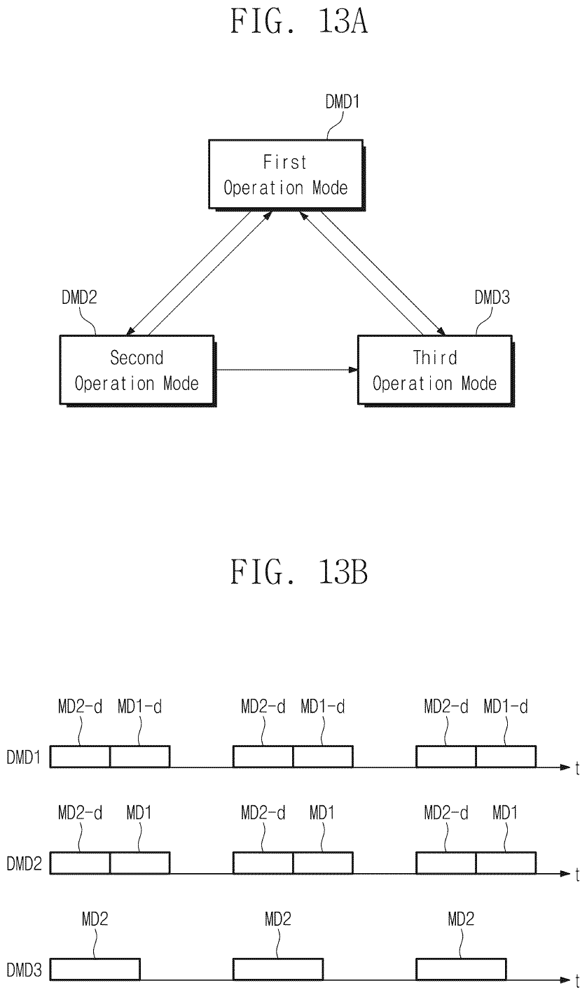

FIG. 13A is a view illustrating an operation of the sensor driver 200C (see FIG. 5) according to one or more embodiments of the present disclosure. FIG. 13B is a view illustrating an operation of the sensor driver 200C (see FIG. 5) according to one or more embodiments of the present disclosure.

Referring to FIGS. 5 and 13A, the sensor driver 200C may be selectively driven in any one of a first operation mode DMD1, a second operation mode DMD2, or a third operation mode DMD3.

The first operation mode DMD1 may be referred to as a touch-and-pen-standby mode, the second operation mode DMD2 may be referred to as a touch-activation-and-pen-standby mode, and the third operation mode DMD3 may be referred to as a pen activation mode. The first operation mode DMD1 may be a mode for waiting for the first input 2000 and the second input 3000. The second operation mode DMD2 may be a mode for sensing the first input 2000 and waiting for the second input 3000. The third operation mode DMD3 may be a mode for sensing the second input 3000.

According to one or more embodiments of the present disclosure, the sensor driver 200C may be first driven in the first operation mode DMD1. When the first input 2000 is sensed in the first operation mode DMD1, the sensor driver 200C may be switched (or changed) to the second operation mode DMD2. Alternatively, when the second input 3000 is sensed in the first operation mode DMD1, the sensor driver 200C may be switched (or changed) to the third operation mode DMD3.

According to one or more embodiments of the present disclosure, when the second input 3000 is sensed in the second operation mode DMD2, the sensor driver 200C may be switched to the third operation mode DMD3. When the first input 2000 is released (or not sensed) in the second operation mode DMD2, the sensor driver 200C may be switched to the first operation mode DMD1. When the second input 3000 is released (or not sensed) in the third operation mode DMD3, the sensor driver 200C may be switched to the first operation mode DMD1.

Referring to FIGS. 5, 13A, and 13B, operations in the first to third operation modes DMD1, DMD2, and DMD3 are illustrated in order of time (t).

In the first operation mode DMD1, the sensor driver 200C may be repeatedly driven in a second mode MD2-d and a first mode MD1-d. During the second mode MD2-d, the sensor layer 200 may be scan-driven to detect the second input 3000. During the first mode MD1-d, the sensor layer 200 may be scanned and driven to detect the first input 2000. Although FIG. 13B illustrates that the sensor driver 200C operates in the first mode MD1-d subsequent to the second mode MD2-d, the operating order of the sensor driver 200C is not limited thereto.

In the second operation mode DMD2, the sensor driver 200C may be repeatedly driven in the second mode MD2-d and a first mode MD1. During the second mode MD2-d, the sensor layer 200 may be scanned and driven to detect the second input 3000. During the first mode MD1, the sensor layer 200 may be scanned and driven to detect coordinates formed by the first input 2000.

In the third operation mode DMD3, the sensor driver 200C may be driven in a second mode MD2. During the second mode MD2, the sensor layer 200 may be scanned and driven to detect coordinates formed by the second input 3000. In the third operation mode DMD3, the sensor driver 200C may not operate in the first mode MD1-d or MD1 until the second input 3000 is released (or not detected).

Referring also to FIG. 7, during the first mode MD1-d of the first operation mode DMD1 and the first mode MD1 of the second operation mode DMD2, the third electrode groups 230G and the fourth electrode group 240G may be grounded, or may receive a constant voltage. Alternatively, during the first mode MD1-d and the first mode MD1, the third electrode groups 230G and the fourth electrode group 240G may be floated. Alternatively, during the first mode MD1-d and the first mode MD1, the third electrode groups 230G and the fourth electrode group 240G may receive a signal in phase with a signal applied to the first electrode groups 210G. In this case, touch noise may be reduced or prevented from being introduced through the third electrode groups 230G and the fourth electrode group 240G.

In the second mode MD2-d of the first operation mode DMD1 or the second operation mode DMD2 and the second mode MD2 of the third operation mode DMD3, one end of each of the third electrode groups 230G and the fourth electrode group 240G may be floated. In addition, in the second mode MD2-d and the second mode MD2, an opposite end of each of the third electrode groups 230G and the fourth electrode group 240G may be grounded or floated. Accordingly, compensation of the sensing signal may be maximized due to coupling between the first electrode groups 210G and the third electrode groups 230G, and due to coupling between the second electrode groups 220G and the fourth electrode groups 240G.

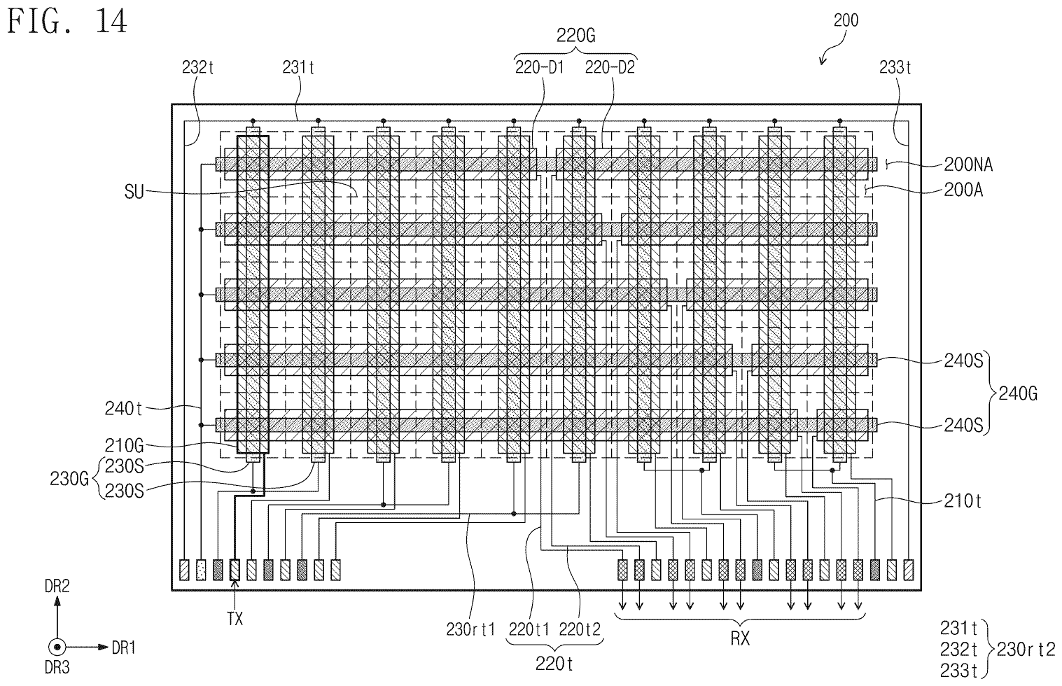

FIG. 14 is a view illustrating a first mode according to one or more embodiments of the present disclosure.

Referring to FIGS. 5, 13B, and 14, the first mode MD1-d in the first operation mode DMD1 and the first mode MD1 in the second operation mode DMD2 may include a mutual capacitance detection mode. FIG. 14 is a view illustrating describing a mutual capacitance detection mode in the first mode MD1-d of the first operation mode DMD1 and the first mode MD1 of the second operation mode DMD2.

In the mutual capacitance detection mode, the sensor driver 200C may sequentially apply transmit signals TX to the first electrode groups 210G, and may detect coordinates for the first input 2000 by using a receive signal RX detected through the second electrode groups 220G. For example, the sensor driver 200C may be configured to calculate an input coordinate by sensing a change in mutual capacitance between the first electrode groups 210G and the second electrode groups 220G.

FIG. 14 illustrates that the transmit signal TX is applied to one first electrode group 210G, and that the receive signal RX is output from the second electrode groups 220G. To clarify a signal expression, one first electrode group 210G applied with the transmit signal TX is displayed in bold in FIG. 14. The sensor driver 200C may detect input coordinates for the first input 2000 by sensing the change in capacitance between the first electrode groups 210G and the second electrode groups 220G.

According to one or more embodiments of the present disclosure, at least one of the first mode MD1-d of the first operation mode DMD1 or the first mode MD1 of the second operation mode DMD2 may further include a mode (self-capacitance detection mode) for detecting self-capacitance. The sensor driver 200C may be configured to output driving signals to the first electrode groups 210G and the second electrode groups 220G in the self-capacitance detection mode, and to calculate input coordinates by sensing the change in capacitance of each of the first electrode groups 210G and the second electrode groups 220G. The operation for outputting the driving signals to the first electrode groups 210G and the second electrode groups 220G may be separately operated in mutually different timings, or may temporally overlap each other.

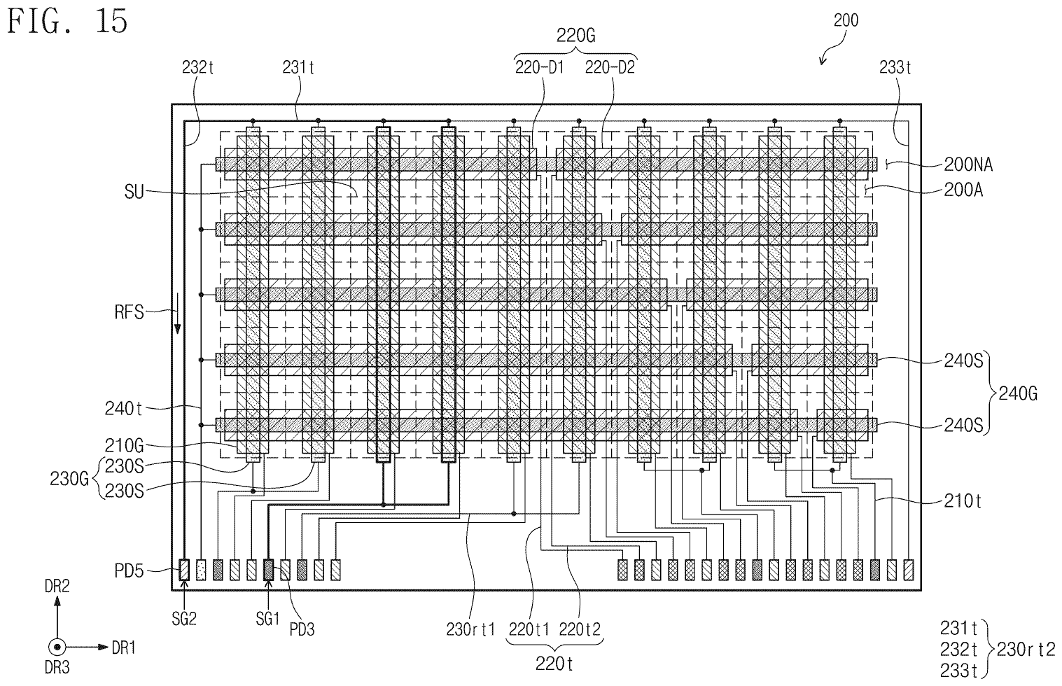

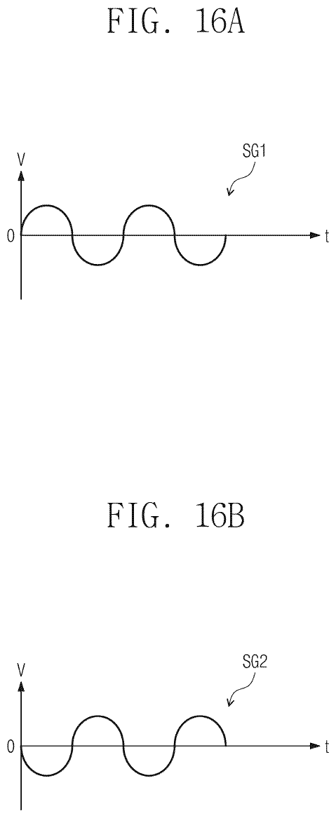

FIG. 15 is a view illustrating a second mode according to one or more embodiments of the present disclosure. FIG. 15 is a view illustrating a second mode (e.g., a charging driving mode), according to one or more embodiments of the present disclosure. FIG. 16A is a graph illustrating a waveform of a first signal according to one or more embodiments of the present disclosure. FIG. 16B is a graph illustrating a waveform of a second signal according to one or more embodiments of the present disclosure.

Referring to FIGS. 15, 16A, and 16B, the second mode MD2 may include the charging driving mode. The charging driving mode may include a search-charging driving mode and a tracking-charging driving mode.

The search-charging driving mode may be a driving mode before sensing the position of the pen. Accordingly, a first signal SG1 or a second signal SG2 may be provided to all channels included in the sensor layer 200. In other words, in the search-charging driving mode, the entire area of the sensor layer 200 may be scanned. When the pen PN is sensed in the search-charging driving mode, the sensor layer 200 may be driven in the tracking-charging driving mode. For example, in the tracking-charging driving mode, the sensor driver 200C may sequentially output the first signal SG1 and the second signal SG2 to a region overlapped with a point where the pen PN is sensed, instead of the entire portion of the sensor layer 200.

In the charging driving mode, the sensor driver 200C may apply the first signal SG1 to a first pad of the third pads PD3 and the fifth pads PD5, and may apply the second signal SG2 to a second pad, which is different from the first pad, of the third pads PD3 and the fifth pads PD5. The second signal SG2 may have a phase that is inverse to the phase of the first signal SG1. For example, the first signal SG1 may be a sinusoidal signal.

Because the first signal SG1 and the second signal SG2 are applied to the at least two pads, a current RFS may have a current path formed from the first pad to the second pad. In addition, because the first signal SG1 and the second signal SG2 are sinusoidal signals in an inverse phase relationship, the direction of the current RFS may be periodically changed. According to one or more embodiments of the present disclosure, the first signal SG1 and the second signal SG2 may be square wave signals having phases that are inverse to each other.

When the first signal SG1 and the second signal SG2 have phases that are inverse to each other, noise caused to the display layer 100 (see FIG. 4) by the first signal SG1 may be canceled by noise caused by the second signal SG2. Accordingly, a flicker phenomenon may not occur in the display layer 100, and display quality of the display layer 100 may be improved.

According to one or more embodiments of the present disclosure, the first signal SG1 may be a sinusoidal signal. However, the present disclosure is not limited thereto, and the first signal SG1 may be a square wave signal. In addition, the second signal SG2 may have a corresponding constant voltage. For example, the second signal SG2 may be a ground voltage. In other words, the pad to receive the second signal SG2 may be considered to be grounded. Even in this case, the current RFS may flow from the first pad to the second pad. In addition, even if the second pad is grounded, the direction of the current RFS may be periodically changed because the first signal SG1 is a sinusoidal wave signal or a square wave signal.

FIG. 15 illustrates that the first signal SG1 is applied to one third pad PD3 connected to one third trace line 230rt1, and the second signal SG2 is applied to one fifth pad PD5 connected to the fifth trace line 230rt2. The current RFS may flow through a current path defined by the fifth pad PD5, the fifth trace line 230rt2 connected to the fifth pad PD5, the third electrode group 230G, a portion of a third trace line 230rt1 connected to the third pad PD3, and the third pad PD3. The current path may have a coil shape. Accordingly, in the charging driving mode of the second mode, the resonant circuit of the pen PN may be charged by the current path.

According to the present disclosure, the current path in a loop coil pattern may be implemented by the components included in the sensor layer 200. Accordingly, the electronic device 1000 (see FIG. 1A) may charge the pen PN by using the sensor layer 200. Accordingly, because a component having a coil to charge the pen PN does not need to be separately added, an increase in thickness of the electronic device 1000, an increase in weight of the electronic device 1000, and a decrease in flexibility of the electronic device 1000 may be not made.

In the charging driving mode, the first electrode groups 210G, the second electrode groups 220G, and the fourth electrode group 240G may be grounded, may receive a constant voltage, or may be electrically floated. For example, the first electrode groups 210G, the second electrode groups 220G, and the fourth electrode group 240G may be floated. In this case, the current RFS may not flow to the first electrode groups 210G, the second electrode groups 220G, and the fourth electrode group 240G.

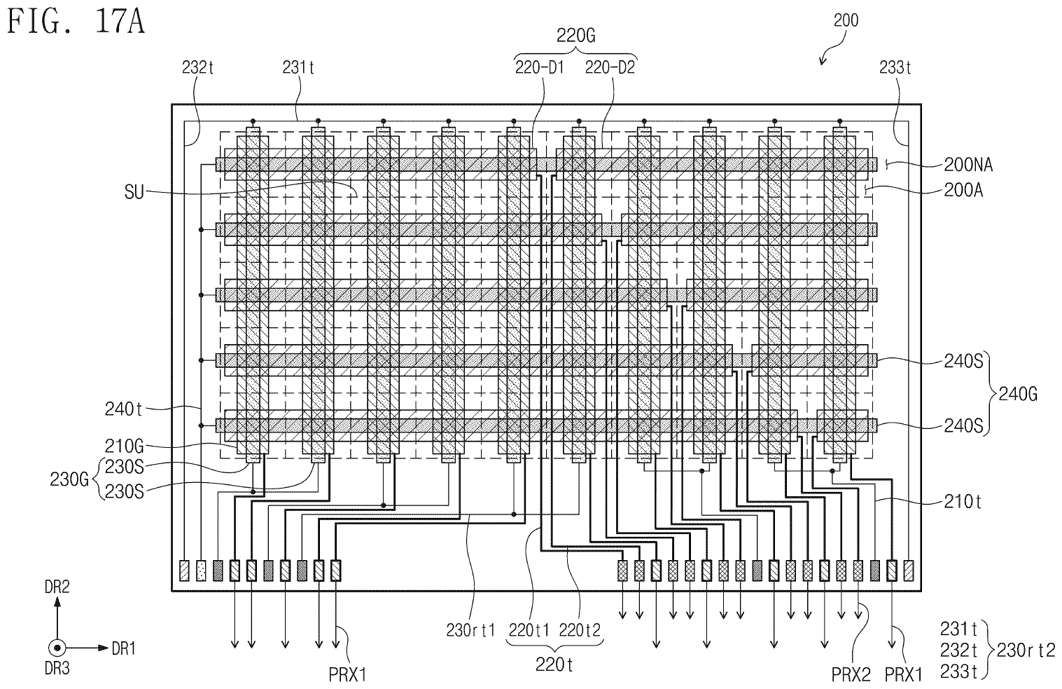

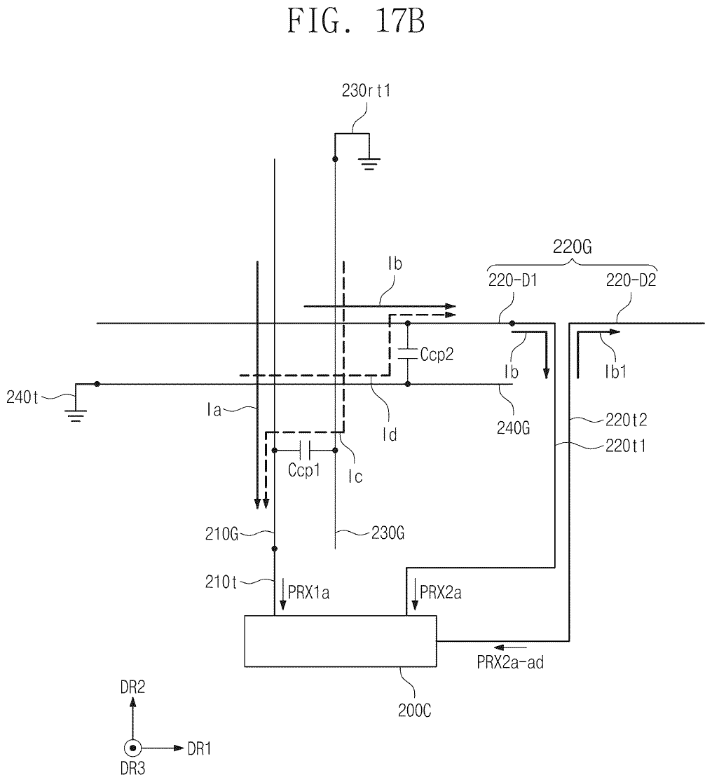

FIG. 17A is a view illustrating a second mode according to one or more embodiments of the present disclosure. FIG. 17B is a view illustrating a second mode according to one or more embodiments of the present disclosure.

Referring to FIGS. 17A and 17B, the second mode may include the charging driving mode and the pen-sensing driving mode. FIGS. 17A and 17B are views illustrating the pen-sensing driving mode. FIG. 17B illustrates an equivalent circuit view of some components of the single sensor layer 200 through which the first to fourth induction currents Ia, Ib, Ic, and Id generated by the pen PN flow.

An RLC resonance circuit of the pen PN may discharge a magnetic field having a resonance frequency while discharging charges. By the magnetic field provided through the pen PN, the first induction current Ia may be generated from the first electrode group 210G, and second induction currents Ib and Ib1 may be generated from the second electrode group 220G. In addition, the third induction current Ic may be generated from the third electrode group 230G, and the fourth induction current Id may be generated from the fourth electrode group 240G.

According to one or more embodiments of the present disclosure, the second electrode group 220G includes the first divided electrode 220-D1 and the second divided electrode 220-D2, and the first divided electrode 220-D1 and the second divided electrode 220-D2 are connected to the (2-1)-th trace line 220t1 and the (2-2)-th trace line 220t2, respectively. Accordingly, the first divided electrode 220-D1 and the second divided electrode 220-D2 in one second electrode group 220G, which sense along the same axis, are connected to the (2-1)-th trace line 220t1 and the (2-2)-th trace line 220t2, respectively, such that a likelihood of the second induction currents Ib and Ib1 being canceled may be reduced or prevented.

A first coupling capacitor Ccp1 may be formed between the third electrode group 230G and the first electrode group 210G, and a second coupling capacitor Ccp2 may be formed between the fourth electrode group 240G and the first divided electrode 220-D1 of the second electrode group 220G. The third induction current Ic may be applied to the first electrode group 210G through the first coupling capacitor Ccp1, and the fourth induction current Id may be applied to the first divided electrode 220-D1 through the second coupling capacitor Ccp2.

The sensor driver 200C may receive a first receive signal PRX1a based on the first induction current Ia and the third induction current Ic from the first divided electrode 220-D1 of the second electrode group 220G, and may receive a second receive signal PRX2a based on the second induction current Ib and the fourth induction current Id from the first divided electrode 220-D1 of the second electrode group 220G. In addition, the sensor driver 200C may receive a third receive signal PRX2a-ad based on the second induction current Ib1 from the second divided electrode 220-D2 of the second electrode group 220G. The sensor driver 200C may detect the input coordinates of the pen PN based on the first receive signal PRX1a, the second receive signal PRX2a, and the third receive signal PRX2a-ad.

According to one or more embodiments of the present disclosure, the ends of the third electrode group 230G and the fourth electrode group 240G may be floated. Accordingly, compensation of the sensing signal may be maximized due to coupling between the first electrode group 210G and the third electrode group 230G, and due to coupling between the first divided electrode 220-D1 and the fourth electrode group 240G.

In addition, opposite ends of the third electrode group 230G and the fourth electrode group 240G may be grounded or floated. Accordingly, the third induction current Ic and the fourth induction current Id may be sufficiently applied to the first electrode group 210G and the first divided electrode 220-D1 due to coupling between the first electrode group 210G and the third electrode group 230G and the coupling between the first divided electrode 220-D1 and the fourth electrode group 240G.

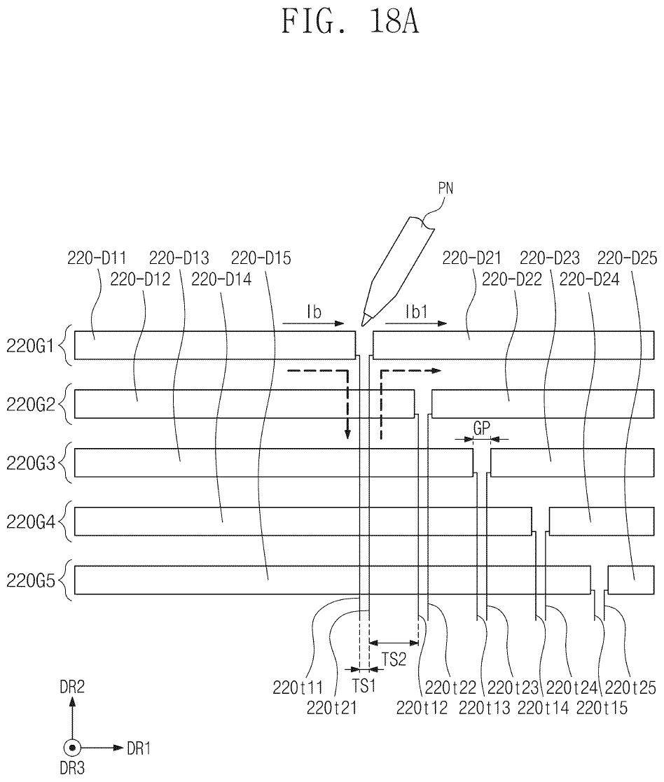

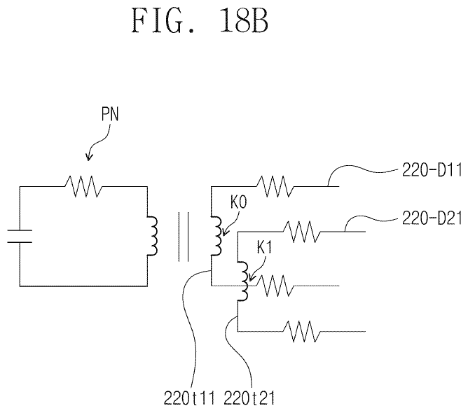

FIG. 18A is a view illustrating a partial configuration of a sensor layer according to one or more embodiments of the present disclosure. FIG. 18B is an equivalent circuit diagram of an input device and a sensor layer according to one or more embodiments of the present disclosure.

Referring to FIGS. 7, 18A, and 18B, the second electrode groups 220G may include a (2-1)-th electrode group 220G1, a (2-2)-th electrode group 220G2, a (2-3)-th electrode group 220G3, a (2-4)-th electrode group 220G4, and a (2-5)-th electrode group 220G5 sequentially arranged in the second direction DR2.

The (2-1)-th electrode group 220G1 may include a (1-1)-th divided electrode 220-D11, and a (2-1)-th divided electrode 220-D21 spaced apart from the (1-1)-th divided electrode 220-D11 in the first direction DR1. The (2-2)-th electrode group 220G2 may include a (1-2)-th divided electrode 220-D12, and a (2-2)-th divided electrode 220-D22 spaced apart from the (1-2)-th divided electrode 220-D12 in the first direction DR1. The (2-3)-th electrode group 220G3 may include a (1-3)-th divided electrode 220-D13, and a (2-3)-th divided electrode 220-D23 spaced apart from the (1-3)-th divided electrode 220-D13 in the first direction DR1. The (2-4)-th electrode group 220G4 may include a (1-4)-th divided electrode 220-D14, and a (2-4)-th divided electrode 220-D24 spaced apart from the (1-4)-th divided electrode 220-D14 in the first direction DR1. The (2-5)-th electrode group 220G5 may include a (1-5)-th divided electrode 220-D15, and a (2-5)-th divided electrode 220-D25 spaced apart from the (1-5)-th divided electrode 220-D15 in the first direction DR1.

The second trace lines 220t include a (1-1)-th divided trace line 220t11 electrically connected to the (1-1)-th divided electrode 220-D11, a (2-1)-th divided trace line 220t21 electrically connected to the (2-1)-th divided electrode 220-D21, a (1-2)-th divided trace line 220t12 electrically connected to the (1-2)-th divided electrode 220-D12, a (2-2)-th divided trace line 220t22 electrically connected to the (2-2)-th divided electrode 220-D22, a (1-3)-th divided trace line 220t13 electrically connected to the (1-3)-th divided electrode 220-D13, a (2-3)-th divided trace line 220t23 electrically connected to the (2-3)-th divided electrode 220-D23, a (1-4)-th divided trace line 220t14 electrically connected to the (1-4)-th divided electrode 220-D14, a (2-4)-th divided trace line 220t24 electrically connected to the (2-4)-th divided electrode 220-D24, a (1-5)-th divided trace line 220t15 electrically connected to the (1-5)-th divided electrode 220-D15, and a (2-5)-th divided trace line 220t25 electrically connected to the (2-5)-th divided electrode 220-D25.

The (1-1)-th divided electrode 220-D11 may be referred to as a first divided electrode, the (2-1)-th divided electrode 220-D21 may be referred to as a second divided electrode, the (1-2)-th divided electrode 220-D12 may be referred to as a third divided electrode, and the (2-2)-th divided electrode 220-D22 may be referred to as a fourth divided electrode. The (1-1)-th divided trace line 220t11 may be referred to as a first line or a (2-1)-th trace line, the (2-1)-th divided trace line 220t21 may be referred to as a second line or a (2-2)-th trace line, and the (1-2)-th divided trace line 220t12 may be referred to as a third line or a (2-3)-th trace line, and the (2-2)-th divided trace line 220t22 may be referred to as a fourth line or a (2-4)-th trace line.

According to one or more embodiments of the present disclosure, the (1-1)-th divided trace line 220t11, the (2-1)-th divided trace line 220t21, the (1-2)-th divided trace line 220t12, the (2-2)-th divided trace line 220t22, the (1-3)-th divided trace line 220t13, and the (2-3)-th divided trace line 220t23 may be sequentially arranged in the first direction DR1.

According to one or more embodiments of the present disclosure, a gap TS1 between the (1-1)-th divided trace line 220t11 and the (2-1)-th divided trace line 220t21 connected to the (1-1)-th divided electrode 220-D11 and the (2-1)-th divided electrode 220-D21, respectively, and which sense the same axis and belong to one (2-1)-th electrode group 220G1, may be smaller than a gap TS2 between the (1-2)-th divided trace line 220t12 and the (2-1)-th divided trace line 220t21 connected to the (1-2)-th divided electrode 220-D12 and the (2-1)-th divided electrode 220-D21, respectively, which belong to the (2-2)-th electrode group 220G2 to sense an axis that is different from that of the (2-1)-th electrode group 220G1.

According to one or more embodiments of the present disclosure, signals provided from the (1-1)-th divided trace line 220t11 and the (2-1)-th divided trace line 220t21 may be sensed differentially. In this case, mutual inductance of a trace line, which affects the distortion of coordinate, may be removed. As the gap between the (1-1)-th divided trace line 220t11 and the (2-1)-th divided trace line 220t21 decreases, a first coupling constant K0 of the (1-1)-th divided trace line 220t11 and a second coupling constant K1 of the (2-1)-th divided trace line 220t21 may be substantially equal to each other. Accordingly, as the (1-1)-th divided trace line 220t11 and the (2-1)-th divided trace line 220t21 are closer to each other, the mutual inductance may be more effectively removed.

According to one or more embodiments of the present disclosure, the width of the (1-1)-th divided electrode 220-D11 in the first direction DR1 may be narrower than the width of the (1-2)-th divided electrode 220-D12 in the first direction DR1, and the width of the (2-1)-th divided electrode 220-D21 in the first direction DR1 may be wider than the width of the (2-2)-th divided electrode 220-D22 in the first direction DR1. The (1-1)-th divided trace line 220t11 and the (2-1)-th divided trace line 220t21 may overlap any one of the (1-2)-th divided electrode 220-D12 or the (2-2)-th divided electrode 220-D22. For example, the (1-1)-th divided trace line 220t11 and the (2-1)-th divided trace line 220t21 may overlap the (1-2)-th divided electrode 220-D12.

The width of the (1-3)-th divided electrode 220-D13 in the first direction DR1 may be wider than the width of the (1-2)-th divided electrode 220-D12 in the first direction DR1, and the width of the (2-3)-th divided electrode 220-D23 in the first direction DR1 may be narrower than the width of the (2-2)-th divided electrode 220-D22 in the first direction DR1. Accordingly, when viewed from the second direction DR2, a gap GP between the (1-3)-th divided electrode 220-D13 and the (2-3)-th divided electrode 220-D23 may be overlapped (e.g., along a second direction DR2) with the (2-1)-th divided electrode 220-D21 and the (2-2)-th divided electrode 220-D22.

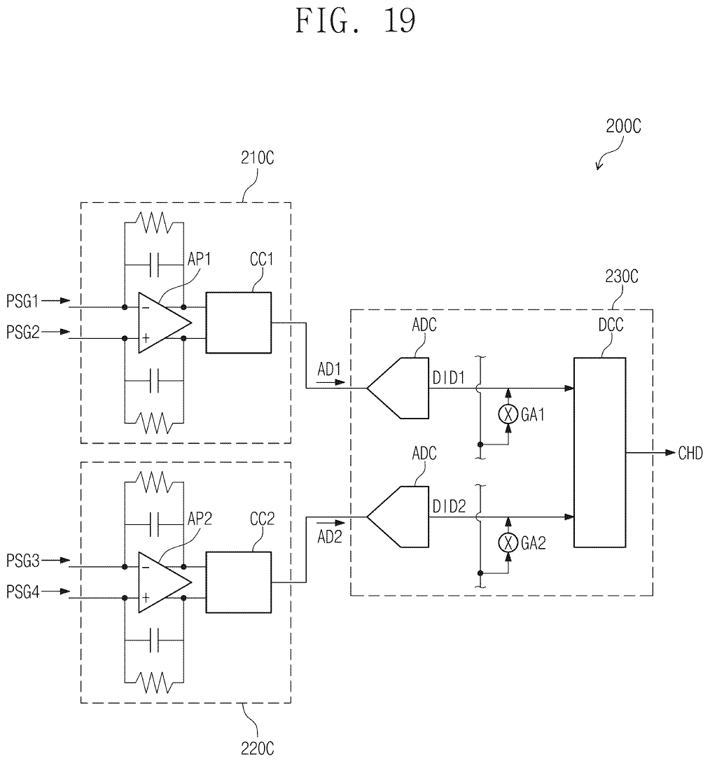

FIG. 19 is a view illustrating the sensor driver 200C according to one or more embodiments of the present disclosure. In FIG. 19, the operation of the sensor driver 200C in the pen-sensing driving mode will be described.

Referring to FIGS. 17A, 18A, and 19, the sensor driver 200C may differentially sense signals received from two different electrode groups. For example, a signal received from the (2-1)-th electrode group 220G1 and a signal received from the (2-2)-th electrode group 220G2 may be differentially sensed.

According to one or more embodiments of the present disclosure, the second trace lines 220t overlap the sensing region 200A. In other words, as compared to the case where the second trace lines are located in the peripheral region 200NA, the second trace lines 220t are widely spread in the sensing region 200A, and mutual inductances between the pen PN and the second trace lines 220t may be different from each other. Accordingly, unlike one or more embodiments of the present disclosure, when the (2-1)-th electrode group 220G1 and the (2-2)-th electrode group 220G2 are directly differentially sensed, the influence by the second trace lines 220t is not removed, so that coordinates may be distorted.

According to one or more embodiments of the present disclosure, before differentially sensing signals received from two different electrode groups, a primary differential sensing operation may be performed to remove the influence by the second trace lines 220t. Mutual inductances of the second trace lines 220t that affect the distortion of coordinates may be removed by the primary differential sensing operation. Accordingly, the accuracy of coordinates sensed by the sensor layer 200 and the sensor driver 200C may be improved. Hereinafter, the operation of the sensor driver 200C will be described in detail.

The sensor driver 200C may include a first differential processing circuit 210C, a second differential processing circuit 220C, and a third differential processing circuit 230C. The first differential processing circuit 210C and the second differential processing circuit 220C may be circuits that perform the primary differential sensing operation to remove the mutual inductances of the second trace lines 220t. The third differential processing circuit 230C may be a circuit to perform a secondary differential sensing operation with respect to signals received from two different electrode groups.

The first differential processing circuit 210C may be configured to receive a first signal PSG1 from the (1-1)-th divided trace line 220t11 connected to the (2-1)-th electrode group 220G1, and a second signal PSG2 from the (2-1)-th divided trace line 220t21, to perform a differential computing operation with respect to the first signal PSG1 and the second signal PSG2, thereby generating first data AD1.

The second differential processing circuit 220C may be configured to receive a third signal PSG3 from the (1-2)-th divided trace line 220t12 connected to another second electrode group, for example, the (2-2)-th electrode group 220G2, and a fourth signal PSG4 from the (2-2)-th divided trace line 220t22, and to perform a differential computing operation with respect to the third signal PSG3 and the fourth signal PSG4, thereby generating second data AD2.

The third differential processing circuit 230C may be configured to perform a differential computing operation with respect to the first data AD1 and the second data AD2 to generate third data CHD.

The sensor driver 200C may be configured to generate the first data AD1 and the second data AD2 through at least one of analog differential processing or digital differential processing, and may be configured to generate the third data CHD using at least one of the analog differential processing or the digital differential processing. According to one or more embodiments of the present disclosure, the sensor driver 200C may generate the first data AD1 and the second data AD2 through the analog differential processing, and may generate the third data CHD through the digital differential processing.

The first differential processing circuit 210C may include a first charge voltage amplifier AP1 and a first current conveyor CC1. The second differential processing circuit 220C may include a second charge voltage amplifier AP2 and a second current conveyor CC2. The third differential processing circuit 230C may include an analog-to-digital converter ADC and a differential computing unit DCC. The components included in each of the first differential processing circuit 210C, the second differential processing circuit 220C, and the third differential processing circuit 230C are not limited to the above-described components. At least some of the above-described components may be omitted, or other components may be added. In addition, the order of connection of the components included in each of the first differential processing circuit 210C, the second differential processing circuit 220C, and the third differential processing circuit 230C may be changed.

The first differential processing circuit 210C may receive the first signal PSG1 and the second signal PSG2, and may perform the differential computing operation with respect to the first signal PSG1 and the second signal PSG2 to generate the first data AD1. The second differential processing circuit 220C may receive the third signal PSG3 and the fourth signal PSG4, and may perform the differential operation on the third signal PSG3 and the fourth signal PSG4 to generate the second data AD2. The step of generating the first data AD1 and the second data AD2 may be referred to as the primary differential processing operation. Mutual inductance affecting the distortion of coordinates may be removed by the primary differential processing operation.

The analog-to-digital converter ADC of the third differential processing circuit 230C may convert the first data AD1 and the second data AD2 to output first digital data DID1 and second digital data DID2, respectively. A first weight GA1 may be applied to the first digital data DID1, and a second weight GA2 may be applied to the second digital data DID2. The first weight GA1 and the second weight GA2 may be the same or different from each other.

First weighted data obtained by applying the first weight GA1 to the first digital data DID1 and second weighted data obtained by applying the second weight GA2 to the second digital data DID2 may be provided to the differential computing unit DCC. The differential computing unit DCC may perform a computing operation with respect to the first weighted data and the second weighted data to output the third data CHD.

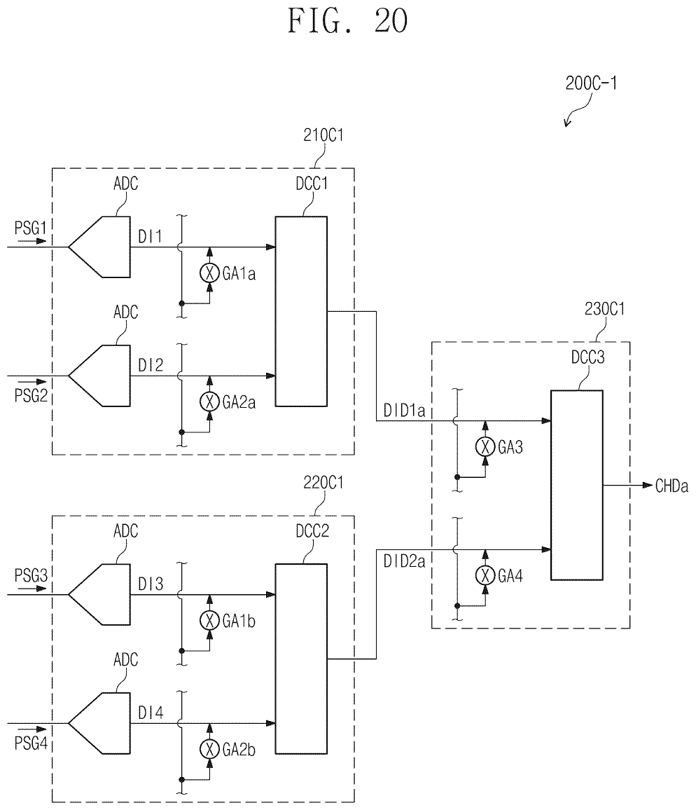

FIG. 20 is a view illustrating a sensor driver 200C-1 according to one or more embodiments of the present disclosure. In the following description with reference to FIG. 20, components described with reference to FIG. 19 are assigned with the same reference numerals, and the details thereof will be omitted.

Referring to FIG. 20, the sensor driver 200C-1 may include a first differential processing circuit 210C1, a second differential processing circuit 220C1, and a third differential processing circuit 230C1.

The sensor driver 200C-1 may be configured to generate first data DID1a and second data DID2a through at least one of analog differential processing or digital differential processing, and may be configured to generate third data CHDa through at least one of the analog differential processing or the digital differential processing.

According to one or more embodiments of the present disclosure, the sensor driver 200C-1 may generate the first data DID1a and the second data DID2a through the digital differential processing, and may generate the third data CHDa through the digital differential processing.

The first differential processing circuit 210C1 may include an analog-to-digital converter ADC and a first differential computing unit DCC1. The second differential processing circuit 220C1 may include an analog-to-digital converter ADC and a second differential computing unit DCC2. The third differential processing circuit 230C1 may include a third differential computing unit DCC3. Components included in each of the first to third differential processing circuits 210C1, 220C1, and 230C1 are not limited to the above-described components. At least some of the above-described components may be omitted, or other components may be added.

The first differential processing circuit 210C1 may receive the first signal PSG1 and the second signal PSG2, and may perform analog-to-digital conversion with respect to the first signal PSG1 and the second signal PSG2 to generate first digital data DI1 and second digital data DI2. A first weight GA1a may be applied to the first digital data DI1, and a second weight GA2a may be applied to the second digital data DI2. The first weight GA1a and the second weight GA2a may be the same, or may be different from each other. The first differential computing unit DCC1 may output the first data DID1a by performing a computing operation with respect to the first digital data DI1 and the second digital data DI2 applied with the first weight GA1a and the second weight GA2a, respectively.

The second differential processing circuit 220C1 may receive the third signal PSG3 and the fourth signal PSG4, and may perform analog-to-digital conversion with respect to the third signal PSG3 and the fourth signal PSG4 to generate third digital data DI3 and fourth digital data DI4. A first weight GA1b may be applied to the third digital data DI3, and a second weight GA2b may be applied to the fourth digital data DI4. The first weight GA1b and the second weight GA2b may be the same, or may be different from each other. The second differential computing unit DCC2 may output the second data DID2a by performing a computing operation with respect to the third digital data DI3 and the fourth digital data DI4 applied with the first weight GA1b and the second weight GA2b, respectively.

The third differential processing circuit 230C1 may receive the first data DID1a and the second data DID2a. A third weight GA3 may be applied to the first data DID1a, and a fourth weight GA4 may be applied to the second data DID2a. The third weight GA3 and the fourth weight GA4 may be the same, or may be different from each other. The third differential computing unit DCC3 may output the third data CHDa by performing a computing operation with respect to the first data DID1a and the second data DID2a applied with the third weight GA3 and the fourth weight GA4, respectively.

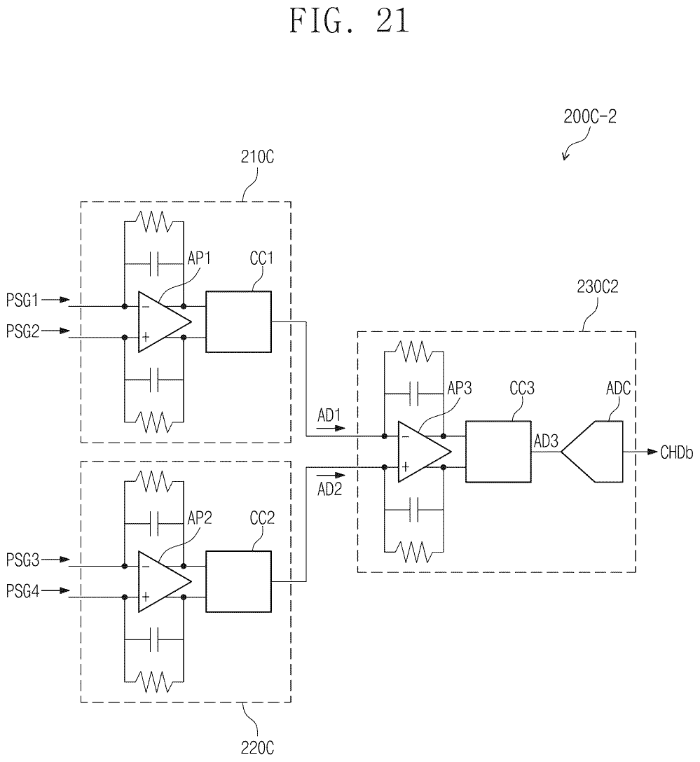

FIG. 21 is a view illustrating a sensor driver 200C-2 according to one or more embodiments of the present disclosure. In the following description with reference to FIG. 21, components described with reference to FIG. 19 are assigned with the same reference numerals, and the details thereof will be omitted.

Referring to FIG. 21, the sensor driver 200C-2 may include the first differential processing circuit 210C, the second differential processing circuit 220C, and a third differential processing circuit 230C2.

The sensor driver 200C-2 may be configured to generate the first data AD1 and the second data AD2 through at least one of analog differential processing or digital differential processing, and may be configured to generate third data CHDb through at least one of the analog differential processing or the digital differential processing. According to one or more embodiments of the present disclosure, the sensor driver 200C-2 may generate the first data AD1 and the second data AD2 through the analog differential processing, and may generate the third data CHDb through the analog differential processing.

The third differential processing circuit 230C2 may include a third charge voltage amplifier AP3, a third current conveyor CC3, and an analog-to-digital converter ADC. The components included in the third differential processing circuit 230C are not limited to the above-described components. At least some of the above-described components may be omitted, and other components may be added. In addition, the connection order of the components included in the third differential processing circuit 230C may be changed.

The third charge voltage amplifier AP3 of the third differential processing circuit 230C may receive the first data AD1 and the second data AD2, and may perform the differential computing operation with respect to the first data AD1 and the second data AD2 to generate third intermediate data AD3. The analog-to-digital converter ADC may convert the third intermediate data AD3 to output the third data CHDb.

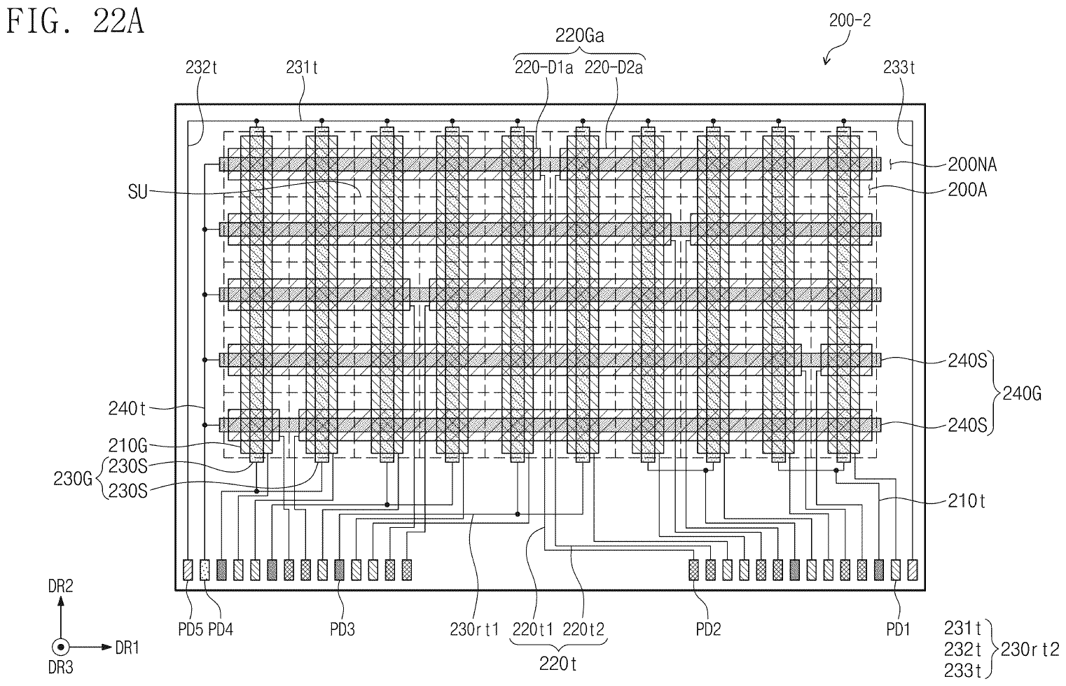

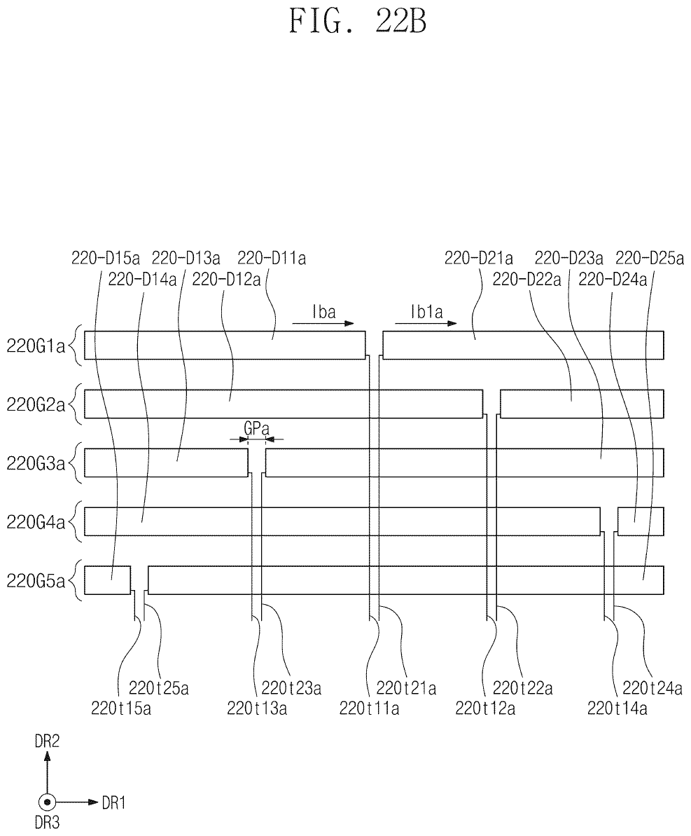

FIG. 22A is a plan view of a sensor layer 200-2 according to one or more embodiments of the present disclosure. FIG. 22B is a view illustrating some components of a sensor layer according to one or more embodiments of the present disclosure. In the following description with reference to FIG. 22A, components described with reference to FIG. 7 are assigned with the same reference numerals, and the details thereof will be omitted.

Referring to FIGS. 22A and 22B, the sensor layer 200-2 may include the plurality of first electrode groups 210G, a plurality of second electrode groups 220Ga, the plurality of third electrode groups 230G, and the fourth electrode group 240G.

Each of the second electrode groups 220Ga may include a first divided electrode 220-D1a and a second divided electrode 220-D2a. The first divided electrode 220-D1a and the second divided electrode 220-D2a may be spaced apart from each other in the first direction DR1. Each of the first divided electrode 220-D1a and the second divided electrode 220-D2a may extend in the first direction DR1.

The second electrode groups 220Ga may include a (2-1)-th electrode group 220G1a, a (2-2)-th electrode group 220G2a, a (2-3)-th electrode group 220G3a, a (2-4)-th electrode group 220G4a, and a (2-5)-th electrode group 220G5a sequentially arranged in the second direction DR2.

The (2-1)-th electrode group 220G1a may include a (1-1)-th divided electrode 220-D11a, and a (2-1)-th divided electrode 220-D21a spaced apart from the (1-1)-th divided electrode 220-D11a in the first direction DR1. The (2-2)-th electrode group 220G2a may include a (1-2)-th divided electrode 220-D12a, and a (2-2)-th divided electrode 220-D22a spaced apart from the (1-2)-th divided electrode 220-D12a in the first direction DR1. The (2-3)-th electrode group 220G3a may include a (1-3)-th divided electrode 220-D13a, and a (2-3)-th divided electrode 220-D23a spaced apart from the (1-3)-th divided electrode 220-D13a in the first direction DR1. The (2-4)-th electrode group 220G4a may include a (1-4)-th divided electrode 220-D14a, and a (2-4)-th divided electrode 220-D24a spaced apart from the (1-4)-th divided electrode 220-D14a in the first direction DR1. The (2-5)-th electrode group 220G5a may include a (1-5)-th divided electrode 220-D15a, and a (2-5)-th divided electrode 220-D25a spaced apart from the (1-5)-th divided electrode 220-D15a in the first direction DR1.

The second trace lines 220t include a (1-1)-th divided trace line 220t11a electrically connected to the (1-1)-th divided electrode 220-D11a, a (2-1)-th divided trace line 220t21a electrically connected to the (2-1)-th divided electrode 220-D21a, a (1-2)-th divided trace line 220t12a electrically connected to the (1-2)-th divided electrode 220-D12a, a (2-2)-th divided trace line 220t22a electrically connected to the (2-2)-th divided electrode 220-D22a, a (1-3)-th divided trace line 220t13a electrically connected to the (1-3)-th divided electrode 220-D13a, a (2-3)-th divided trace line 220t23a electrically connected to the (2-3)-th divided electrode 220-D23a, a (1-4)-th divided trace line 220t14a electrically connected to the (1-4)-th divided electrode 220-D14a, a (2-4)-th divided trace line 220t24a electrically connected to the (2-4)-th divided electrode 220-D24a, a (1-5)-th divided trace line 220t15a electrically connected to the (1-5)-th divided electrode 220-D15a, and a (2-5)-th divided trace line 220t25a electrically connected to the (2-5)-th divided electrode 220-D25a

According to one or more embodiments of the present disclosure, the (1-5)-th divided trace line 220t15a, the (2-5)-th divided trace line 220t25a, the (1-3)-th divided trace line 220t13a, the (2-3)-th divided trace line 220t23a, the (1-1)-th divided trace line 220t11a, the (2-1)-th divided trace line 220t21a, the (1-2)-th divided trace line 220t12a, the (2-2)-th divided trace line 220t22a, the (1-4)-th divided trace line 220t14a, and the (2-4)-th divided trace line 220t24a may be sequentially arranged in the first direction DR1.

According to one or more embodiments of the present disclosure, the width of the (1-1)-th divided electrode 220-D11a in the first direction DR1 may be narrower than the width of the (1-2)-th divided electrode 220-D12a in the first direction DR1, and the width of the (2-1)-th divided electrode 220-D21a in the first direction DR1 may be wider than the width of the (2-2)-th divided electrode 220-D22a in the first direction DR1.

The width of the (1-3)-th divided electrode 220-D13a in the first direction DR1 may be narrower than the width of the (1-1)-th divided electrode 220-D11a in the first direction DR1, and the width of the (2-3)-th divided electrode 220-D23a in the first direction DR1 may be wider than the width of the (2-1)-th divided electrode 220-D21a in the first direction DR1. Accordingly, when viewed from the second direction DR2, a gap GPa between the (1-3)-th divided electrode 220-D13a and the (2-3)-th divided electrode 220-D23a may overlap the (1-1)-th divided electrode 220-D11a and the (1-2)-th divided electrode 220-D12a.

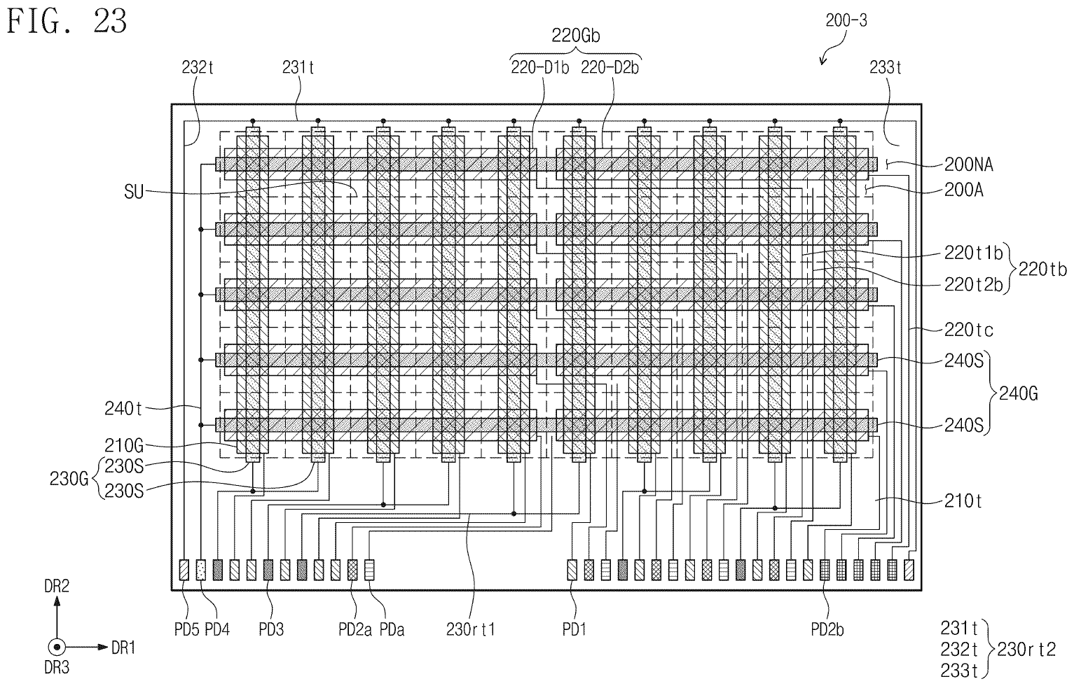

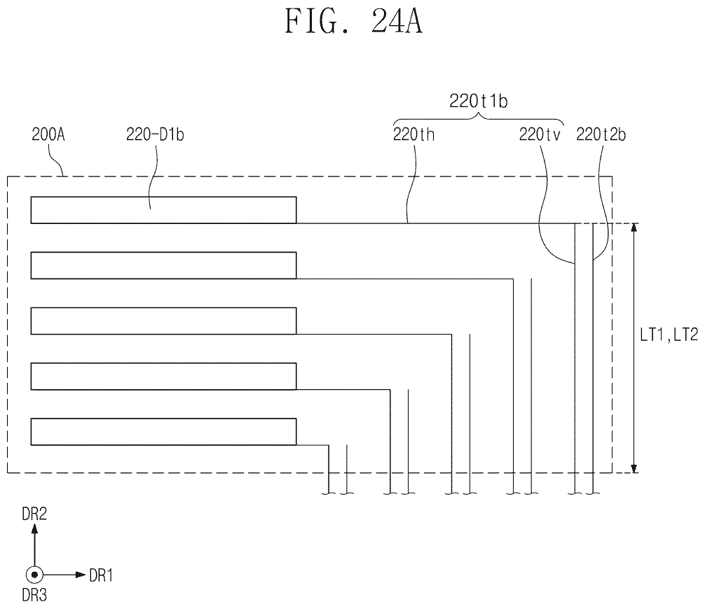

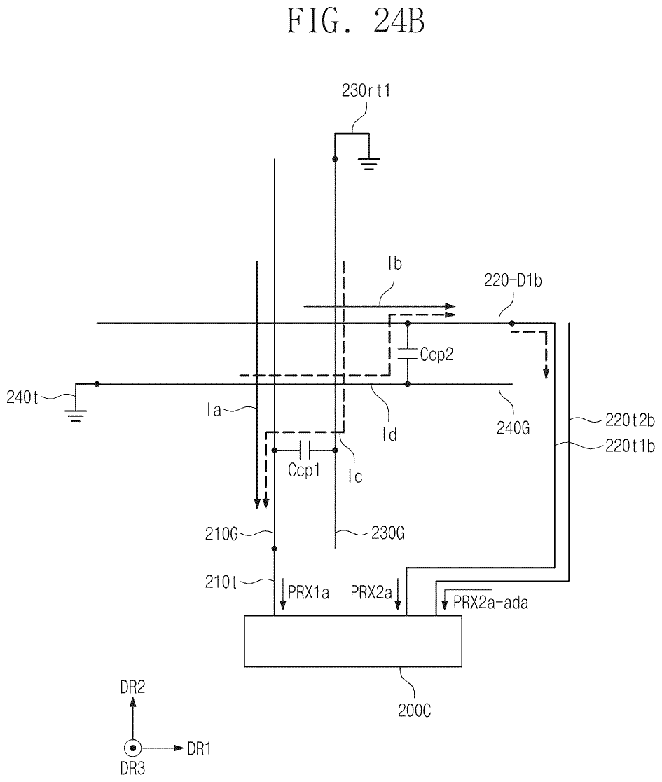

FIG. 23 is a plan view of a sensor layer 200-3 according to one or more embodiments of the present disclosure. FIG. 24A is a view illustrating some components of the sensor layer 200-3 according to one or more embodiments of the present disclosure. FIG. 24B is a view to describe a second mode according to one or more embodiments of the present disclosure. In the following description with reference to FIG. 23, components described with reference to FIG. 7 are assigned with the same reference numerals, and the details thereof will be omitted.

Referring to FIG. 23, the sensor layer 200-3 may include the plurality of first electrode groups 210G, a plurality of second electrode groups 220Gb, the plurality of third electrode groups 230G, and the fourth electrode group 240G, which are located in the sensing region 200A.

Each of the second electrode groups 220Gb may include a first divided electrode 220-D1b and a second divided electrode 220-D2b. The first divided electrode 220-D1b and the second divided electrode 220-D2b may be spaced apart from each other in the first direction DR1. Each of the first divided electrode 220-D1b and the second divided electrode 220-D2b may extend in the first direction DR1.

The first divided electrodes 220-D1b may be arranged to be spaced apart from each other in the second direction DR2, and the second divided electrodes 220-D2b may be arranged to be spaced apart from each other in the second direction DR2. According to one or more embodiments of the present disclosure, the lengths or the widths of the first divided electrodes 220-D1b in the first direction DR1 may be equal to each other, and the lengths or the widths of the second divided electrodes 220-D2b in the first direction DR1 may be equal to each other.

The sensor layer 200-3 may further include second trace lines 220tb and 220tc. The second trace lines 220tb and 220tc may include the first divided trace lines 220tb and the second divided trace lines 220tc. At least some of the first divided trace lines 220tb may be electrically connected to the first divided electrodes 220-D1b, and the second divided trace lines 220tc may be electrically connected to the second divided electrodes 220-D2b.

According to one or more embodiments of the present disclosure, the first divided trace lines 220tb may overlap the sensing region 200A, and may be insulated from at least some of the second divided electrodes 220-D2b while crossing the at least some of the second divided electrodes 220-D2b. The second divided trace lines 220tc may be located in the peripheral region 200NA. However, this is provided only for the illustrative purpose, and at least some of the second divided trace lines 220tc may overlap the sensing region 200A.

FIG. 24A illustrates that the first divided electrodes 220-D1b and the first divided trace lines 220tb. Each of the first divided trace lines 220tb may include a (2-1)-th trace line 220t1b electrically connected to the relevant first divided electrode 220-D1b, and a (2-2)-th trace line 220t2b spaced apart from (2-1)-th trace line 220t1b in the first direction DR1 while extending in the second direction DR2. The (2-1)-th trace line 220t1b may be referred to as a first line, and the (2-2)-th trace line 220t2b may be referred to as a second line.

The (2-2)-th trace line 220t2b may face the (2-1)-th trace line 220t1b. For example, the (2-1)-th trace line 220t1b may include a first portion 220th extending in the first direction DR1 and a second portion 220tv extending from the first portion 220th in the second direction DR2, and the (2-2)-th trace line 220t2b may face the second portion 220tv.

One end of the (2-1)-th trace line 220t1b may be connected to the first divided electrode 220-D1b, and an opposite end of the (2-1)-th trace line 220t1b may be electrically connected to the sensor driver 200C through a second pad PD2a. One end of the (2-2)-th trace line 220t2b may be floated, and an opposite end of the (2-2)-th trace line 220t2b may be electrically connected to the sensor driver 200C through a pad PDa. One end of the second divided trace line 220tc may be connected to the second divided electrode 220-D2b, and the opposite end of the second divided trace line 220tc may be electrically connected to the sensor driver 200C through a second pad PD2b.

Referring to FIGS. 5, 24A, and 24B, the RLC resonance circuit of the pen PN may emit a magnetic field having a resonance frequency while discharging the charges. The first induction current Ia may be generated from the first electrode group 210G, and the second induction current Ib may be generated from the first divided electrode 220-D1b, due to the magnetic field provided by the pen PN. In addition, the third induction current Ic may be generated from the third electrode group 230G, and the fourth induction current Id may be generated from the fourth electrode group 240G.

The first coupling capacitor Ccp1 may be formed between the third electrode group 230G and the first electrode group 210G, and the second coupling capacitor Ccp2 may be formed between the fourth electrode group 240G and the first divided electrode 220-D1b. The third induction current Ic may be transferred to the first electrode group 210G through the first coupling capacitor Ccp1, and the fourth induction current Id may be transferred to the first divided electrode 220-D1b through the second coupling capacitor Ccp2.

The sensor driver 200C may receive a first receive signal PRX1a, which are based on the first induction current Ia and the third induction current Ic, from the first electrode group 210G, and may receive a second receive signal PRX2a, which are based on the second induction current Ib and the fourth induction current Id, from the first divided electrode 220-D1b. In addition, the sensor driver 200C may receive a third receive signal PRX2a-ada from the (2-2)-th trace line 220t2b. The sensor driver 200C may detect coordinates of an input made by the pen PN based on the first receive signal PRX1a, the second receive signal PRX2a, and the third receive signal PRX2a-ada.

According to one or more embodiments of the present disclosure, a length LT1 of the (2-1)-th trace line 220t1b in the second direction DR2 may be substantially equal to a length LT2 of the (2-2)-th trace line 220t2b in the second direction DR2 in the sensing region 200A. The sensor driver 200C may differentially sense the second receive signal PRX2a that is provided through the (2-1)-th trace line 220t1b and the third receive signal PRX2a-ada that is provided through the (2-2)-th trace line 220t2b. In this case, mutual inductance affecting the distortion of coordinates may be removed.

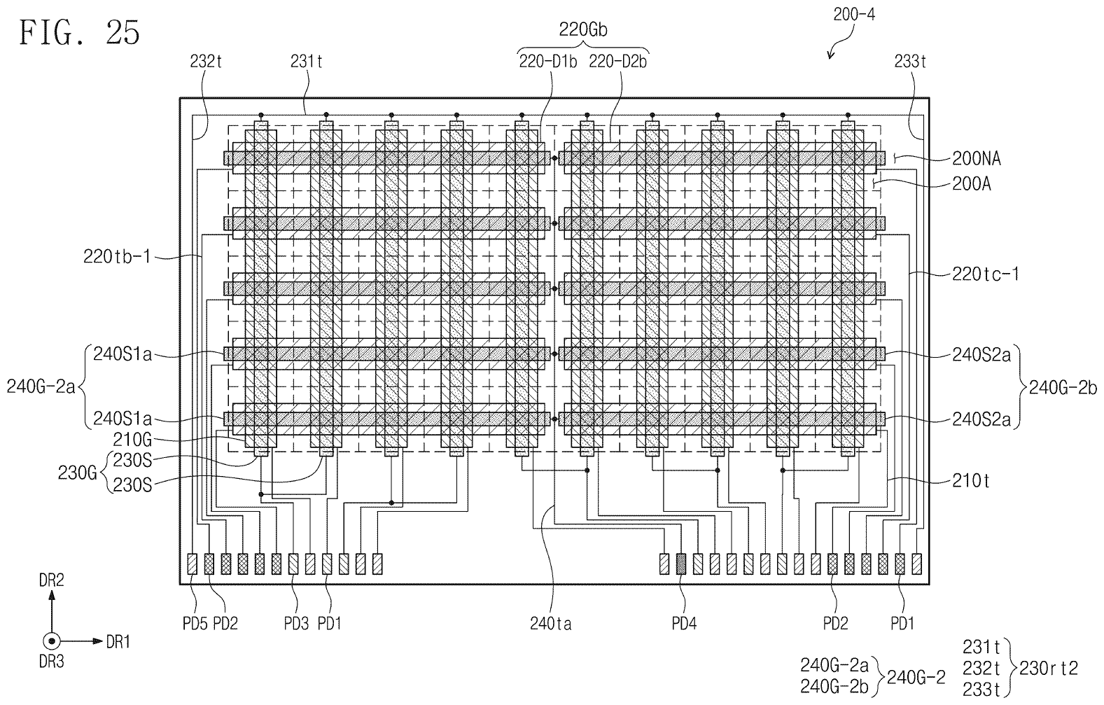

FIG. 25 is a plan view of a sensor layer 200-4 according to one or more embodiments of the present disclosure. In the following description with reference to FIG. 25, components described with reference to FIG. 7 are assigned with the same reference numerals, and the details thereof will be omitted.

Referring to FIG. 25, the sensor layer 200-4 may include the plurality of first electrode groups 210G, the plurality of second electrode groups 220Gb, the plurality of third electrode groups 230G, and a plurality of fourth electrode groups 240G-2.

The second electrode groups 220Gb may include the first divided electrode 220-D1b and the second divided electrode 220-D2b. The first divided electrode 220-D1b and the second divided electrode 220-D2b may be spaced apart from each other in the first direction DR1. Each of the first divided electrode 220-D1b and the second divided electrode 220-D2b may extend in the first direction DR1.

The first divided electrodes 220-D1b may be arranged to be spaced apart from each other in the second direction DR2, and the second divided electrodes 220-D2b may be arranged to be spaced apart from each other in the second direction DR2. According to one or more embodiments of the present disclosure, the lengths or the widths of the first divided electrodes 220-D1b in the first direction DR1 may be equal to each other, and the lengths or the widths of the second divided electrodes 220-D2b in the first direction DR1 may be equal to each other.

The sensor layer 200-4 may further include second trace lines 220tb-1 and 220tc-1. The second trace lines 220tb-1 and 220tc-1 may include the first divided trace lines 220tb-1 and the second divided trace lines 220tc-1. The first divided trace lines 220tb-1 are electrically connected in one-to-one correspondence to the first divided electrodes 220-D1b, and the second divided trace lines 220tc may be electrically connected in one-to-one correspondence to the second divided electrodes 220-D2b. The first divided trace line 220tb-1 may be referred to as a (2-1)-th trace line or a first line, and the second divided trace line 220tc-1 may be referred to as a (2-2)-th trace line or a second line.

According to one or more embodiments of the present disclosure, the first divided trace lines 220tb-1 and the second divided trace lines 220tc-1 may overlap the non-display region 100NA (see FIG. 4) or the peripheral region 200NA. The first divided trace lines 220tb-1 and the second divided trace lines 220tc-1 may be spaced apart from each other while interposing the first divided electrodes 220-D1b and the second divided electrode 220-D2b between the first divided trace lines 220tb-1 and the second divided trace lines 220tc-1.

The sensor layer 200-4 may include two fourth electrode groups 240G-2 facing each other in the first direction DR1. The fourth electrode groups 240G-2 may include a (4-1)-th electrode group 240G-2a overlapped with the first divided electrodes 220-D1b and a (4-2)-th electrode group 240G-2b overlapped with the second divided electrodes 220-D2b. The (4-1)-th electrode group 240G-2a includes the plurality of (2-1)-th second auxiliary electrodes 240S1a arranged in the second direction DR2, and the (4-2)-th electrode group 240G-2b may include the plurality of (2-2)-th second auxiliary electrodes 240S2a arranged in the second direction DR2.

The sensor layer 200-4 may further include a fourth trace line 240ta overlapping the sensing region 200A. The fourth trace line 240ta may be located between the (2-1)-th auxiliary electrodes 240S1a and the (2-2)-th auxiliary electrodes 240S2a. All of the (2-1)-th auxiliary electrodes 240S1a and all of the (2-2)-th auxiliary electrodes 240S2 may be connected to one fourth trace line 240ta.

As described above, the input made by the pen may be sensed through the sensor layer, as well as the touch input. Accordingly, the electronic device does not need to further include the additional component (for example, a digitizer) for pen sensing. Accordingly, the electronic device may be thinner, lighter, and more flexible as the digitizer is not added. In addition, at least a portion of the trace lines of the sensor layer may overlap the sensing region or the display region. Accordingly, the area of the peripheral region of the sensor layer may be reduced. Accordingly, the area occupied by the peripheral region on the front surface of the electronic device may be reduced, and the narrower bezel may be implemented. In addition, the sensor driver may be configured to perform the primary differential sensing operation for removing the influence by the trace lines before performing the differential sensing with respect to the signal received from the two electrode groups different from each other. The mutual inductance of the trace lines exerting an influence on the distortion of coordinates may be removed through the primary differential sensing operation. Accordingly, the accuracy of coordinates sensed by the sensor layer and the sensor driver may be improved.

Although one or more embodiments of the present disclosure has been described for illustrative purposes, those skilled in the art will appreciate that various modifications, and substitutions are possible, without departing from the scope and spirit of the invention as disclosed in the accompanying claims. Accordingly, the technical scope of the present disclosure is not limited to the detailed description of this specification, but should be defined by the claims.

While the present disclosure has been described with reference to embodiments thereof, it will be apparent to those of ordinary skill in the art that various changes and modifications may be made thereto without departing from the spirit and scope of the present disclosure as set forth in the following claims, with functional equivalents thereof to be included therein.

What is claimed is:

1. An electronic device comprising:
a sensor layer comprising:
a sensing region;
a peripheral region adjacent to the sensing region;
first electrode groups arranged in a first direction;
second electrode groups crossing the first electrode groups, and arranged in a second direction crossing the first direction;
first trace lines electrically connected to the first electrode groups; and
second trace lines electrically connected to the second electrode groups, and comprising:
a (2-1)-th trace line electrically connected to one of the second electrode groups, and having a first length in the second direction; and
a (2-2)-th trace line spaced apart from the (2-1)-th trace line in the first direction while extending in the second direction, and having a second length in the second direction that is substantially equal to the first length; and
a sensor driver configured to drive the sensor layer, and to selectively operate in a first mode for sensing a touch input, or in a second mode for sensing a pen input.

2. The electronic device of claim 1, wherein each of the second electrode groups comprises a first divided electrode, and a second divided electrode spaced apart from the first divided electrode in the first direction, and
wherein the (2-1)-th trace line is electrically connected to the first divided electrode, and the (2-2)-th trace line is electrically connected to the second divided electrode.

3. The electronic device of claim 2, wherein at least a portion of the (2-1)-th trace line and a portion of the (2-2)-th trace line overlap the sensing region,
wherein the first length of the (2-1)-th trace line overlaps the sensing region, and
wherein the second length of the (2-2)-th trace line overlaps the sensing region.

4. The electronic device of claim 2, wherein the (2-1)-th trace line is connected to the first divided electrode adjacent to the second divided electrode, and
wherein the (2-2)-th trace line is connected to the second divided electrode adjacent to the first divided electrode.

5. The electronic device of claim 2, wherein the (2-1)-th trace line and the (2-2)-th trace line overlap the peripheral region, and are spaced apart from each other with the first divided electrode and the second divided electrode therebetween.

6. The electronic device of claim 1, wherein the second electrode groups comprise:
a (2-1)-th electrode group, a (2-2)-th electrode group, and a (2-3)-th electrode group sequentially arranged in the second direction,
wherein the (2-1)-th electrode group comprises a (1-1)-th divided electrode, and a (2-1)-th divided electrode spaced apart from the (1-1)-th divided electrode in the first direction,
wherein the (2-2)-th electrode group comprises a (1-2)-th divided electrode, and a (2-2)-th divided electrode spaced apart from the (1-2)-th divided electrode in the first direction,
wherein the (2-3)-th electrode group comprises a (1-3)-th divided electrode, and a (2-3)-th divided electrode spaced apart from the (1-3)-th divided electrode in the first direction, and
wherein the second trace lines comprises a (1-1)-th divided trace line electrically connected to the (1-1)-th divided electrode, a (2-1)-th divided trace line electrically connected to the (2-1)-th divided electrode, a (1-2)-th divided trace line electrically connected to the (1-2)-th divided electrode, a (2-2)-th divided trace line electrically connected to the (2-2)-th divided electrode, a (1-3)-th divided trace line electrically connected to the (1-3)-th divided electrode, and a (2-3)-th divided trace line electrically connected to the (2-3)-th divided electrode.

7. The electronic device of claim 6, wherein a gap between the (1-1)-th divided trace line and the (2-1)-th divided trace line is narrower than a gap between the (2-1)-th divided trace line and the (1-2)-th divided trace line.

8. The electronic device of claim 6, wherein the (1-1)-th divided trace line, the (2-1)-th divided trace line, the (1-2)-th divided trace line, the (2-2)-th divided trace line, the (1-3)-th divided trace line, and the (2-3)-th divided trace line are sequentially arranged in the first direction.

9. The electronic device of claim 6, wherein the (1-3)-th divided trace line, the (2-3)-th divided trace line, the (1-1)-th divided trace line, the (2-1)-th divided trace line, the (1-2)-th divided trace line, and the (2-2)-th divided trace line are sequentially arranged in the first direction.

10. The electronic device of claim 6, wherein a width of the (1-1)-th divided electrode in the first direction is narrower than a width of the (1-2)-th divided electrode in the first direction, and
wherein a width of the (2-1)-th divided electrode in the first direction is wider than a width of the (2-2)-th divided electrode in the first direction.

11. The electronic device of claim 10, wherein a width of the (1-3)-th divided electrode in the first direction is wider than the width of the (1-2)-th divided electrode in the first direction, and
wherein a width of the (2-3)-th divided electrode in the first direction is narrower than the width of the (2-2)-th divided electrode in the first direction.

12. The electronic device of claim 10, wherein a width of the (1-3)-th divided electrode in the first direction is narrower than the width of the (1-1)-th divided electrode in the first direction, and
wherein a width of the (2-3)-th divided electrode in the first direction is wider than the width of the (2-1)-th divided electrode in the first direction.

13. The electronic device of claim 6, wherein a gap between the (1-3)-th divided electrode and the (2-3)-th divided electrode overlaps the (2-1)-th divided electrode and the (2-2)-th divided electrode, when viewed from the second direction.

14. The electronic device of claim 6, wherein a gap between the (1-3)-th divided electrode and the (2-3)-th divided electrode overlaps the (1-1)-th divided electrode and the (1-2)-th divided electrode, when viewed from the second direction.

15. The electronic device of claim 1, wherein the (2-1)-th trace line comprises a first portion extending in the first direction, and a second portion extending in the second direction from the first portion, and
wherein the (2-2)-th trace line faces the second portion.

16. The electronic device of claim 1, wherein the sensor driver is configured to receive a first signal through the (2-1)-th trace line and a second signal through the (2-2)-th trace line, and to generate first data by performing a differential computing operation with respect to the first signal and the second signal.

17. The electronic device of claim 16, wherein the second trace lines comprise a (2-3)-th trace line electrically connected to another second electrode group among the second electrode groups, and a (2-4)-th trace line spaced apart from the (2-3)-th trace line in the first direction while extending in the second direction, and
wherein the sensor driver is configured to receive a third signal through the (2-3)-th trace line and a fourth signal through the (2-4)-th trace line, to generate second data by performing a differential computing operation with respect to the third signal and the fourth signal, and to generate third data by performing the differential computing operation with respect to the first data and the second data.

18. The electronic device of claim 17, wherein the sensor driver is configured to generate the first data and the second data through at least one of analog differential processing or digital differential processing, and
wherein the sensor driver is configured to generate the third data through at least one of the analog differential processing or the digital differential processing.

19. An electronic device comprising:
a sensor layer comprising:
a sensing region;
a peripheral region adjacent to the sensing region;
first electrode groups in the sensing region and arranged in a first direction;
second electrode groups in the sensing region, and arranged in a second direction crossing the first direction, while crossing the first electrode groups;
a first line electrically connected to one of the second electrode groups;
a second line having a length substantially equal to a length of the first line in the second direction, in the sensing region;
a third line electrically connected to another of the second electrode groups; and
a fourth line having a length substantially equal to a length of the third line in the second direction, in the sensing region; and
a sensor driver configured to drive the sensor layer, configured to selectively operate in a first mode for sensing a touch input or in a second mode for sensing a pen input, configured to receive a first signal through the first line and a second signal through the second line, configured to generate first data by performing a differential computing operation with respect to the first signal and the second signal, configured to receive a third signal through the third line and a fourth signal through the fourth line, configured to generate second data by performing a differential computing operation with respect to the third signal and the fourth signal, and configured to generate third data by performing a differential computing operation with respect to the first data and the second data.

20. The electronic device of claim 19, wherein the one of the second electrode groups comprises a first divided electrode, and a second divided electrode spaced apart from the first divided electrode in the first direction,
wherein the another of the second electrode groups comprises a third divided electrode, and a fourth divided electrode spaced apart from the third divided electrode in the first direction,
wherein the first line is electrically connected to the first divided electrode, and the second line is electrically connected to the second divided electrode, and
wherein the third line is electrically connected to the third divided electrode, and the fourth line is electrically connected to the fourth divided electrode.

21. The electronic device of claim 20, wherein the first line and the second line are insulated from one of the third divided electrode or the fourth divided electrode while crossing the third divided electrode and the fourth divided electrode.

22. The electronic device of claim 20, wherein the first line comprises a first portion extending in the first direction, and a second portion extending in the second direction from the first portion, and
wherein the second line faces the second portion of the first line.

23. The electronic device of claim 20, wherein the sensor driver is connected to one end of the second line, and an opposite end of the second line is floated.

24. An electronic device comprising:
first electrode groups in a sensing region, and arranged in a first direction;
second electrode groups crossing the first electrode groups in the sensing region, and arranged in a second direction crossing the first direction;
a first line in the sensing region, and electrically connected to one of the second electrode groups;
a second line in the sensing region, and adjacent to the first line in the first direction; and
a third line in the sensing region, and electrically connected to another of the second electrode groups,
wherein a gap between the first line and the second line is narrower than a gap between the second line and the third line, and
wherein a length of a portion of the first line in the sensing region is substantially equal to a length of a portion of the second line in the sensing region.

25. The electronic device of claim 24, wherein the one of the second electrode groups comprises a first divided electrode, and a second divided electrode spaced apart from the first divided electrode in the first direction, and
wherein the first line is electrically connected to the first divided electrode, and the second line is electrically connected to the second divided electrode.

26. The electronic device of claim 24, wherein the first line comprises a first portion extending in the first direction, and a second portion extending in the second direction from the first portion, and
wherein the second line faces the second portion of the first line while extending in the second direction.
